(19) United States
(12) Patent Application Publication
(10) Pub. No.: US 2026/0225003 A1
(43) Pub. Date: Aug. 6, 2026

(54) HIGH TEMPERATURE SOLVENT SEPARATION WITH ADVANCED STRIPPER AND DIRECT CONTACT CONDENSER

(71) Applicant: Board of Regents, The University of Texas System, Austin, TX (US)

(72) Inventors: Gary Rochelle, Austin, TX (US); Athreya Suresh Babu, Austin, TX (US)

(21) Appl. No.: 19/148,833

(22) PCT Filed: Jan. 18, 2024
(86) PCT No.: PCT/US2024/012004

§ 371 Date: Jul. 17, 2025

Related U.S. Application Data
(60) Provisional application No. 63/440,811, filed on Jan. 24, 2023.

(51) Int. Cl. B01D 19/00; B01D 5/00; B01D 53/14; B01D 53/18

(52) U.S. Cl. CPC B01D 19/0005; B01D 5/003; B01D 53/1425; B01D 53/1475; B01D 53/1493; B01D 53/18; B01D 2252/204; B01D 2257/504

(57) ABSTRACT

Methods and systems described herein improve energy efficiency and costs of separating components from high temperature solvents. A heat exchanger used to capture heat from a stripper before a final condensation step may be replaced with an additional section of packing. This additional section of packing may be at the top of the stripper column and may act as a direct contact condenser. Additionally, a cold rich split may flow into the additional section of packing rather than be mixed with a warm rich bypass. This direct contact condenser configuration may increase energy efficiency and reduce capital costs.

### CROSS-REFERENCE TO RELATED APPLICATION

This application claims the benefit of and priority to U.S. Provisional Application No. 63/440,811, filed on Jan. 24, 2023, and titled “HIGH TEMPERATURE SOLVENT SEPARATION WITH ADVANCED STRIPPER AND DIRECT CONTACT CONDENSER,” the content of which is herein incorporated by reference in its entirety for all purposes.

### FIELD

Embodiments of the present invention are in the field of chemical separation processes and systems. Embodiments of the present invention relate generally to separating carbon dioxide from a high temperature solvent and water.

### BACKGROUND

Global climate change has sparked initiatives to reduce emissions of acidic gases, such as carbon dioxide (CO₂). Removal of acidic gases by absorption/stripping is a commercially promising technology, as it is well suited to sequester CO₂. CO₂ emissions may be produced by a variety of different processes, such as the gas stream produced by coal-fired power plants and fossil fuel powered vehicles. The removal of CO₂ from such gaseous streams can be an expensive process, potentially increasing the cost to produce electricity by 50% or more. Therefore, technology improvements to reduce the costs associated with the removal of CO₂ are highly desirable.

Gas absorption is a process in which soluble components of a gas mixture are dissolved in a liquid. Stripping is essentially the inverse of absorption, as it involves the transfer of volatile components from a liquid mixture into a gas. In a typical CO₂ removal process, absorption is used to remove CO₂ from a combustion gas, and stripping is subsequently used to regenerate the solvent and capture the CO₂ contained in the solvent. Once CO₂ is removed from combustion gases and other gases, the CO₂ can be captured and compressed for use in a number of applications, including sequestration, production of methanol, and tertiary oil recovery.

Cost effective and energy efficient methods and systems to separate carbon dioxide are desired. Embodiments of the present invention address these and other improvements.

### SUMMARY

Methods and systems described herein improve energy efficiency and costs of separating components from high temperature solvents. For example, a heat exchanger used to capture heat from a stripper overhead gas stream before a final condensation step may be replaced with an additional section of packing or trays. This additional section of packing or trays may be at the top of the stripper column and may act as a direct contact condenser. Additionally, a cold rich split may flow into the additional section of packing or trays rather than be mixed with a warm rich bypass. This direct contact condenser configuration may increase energy efficiency and reduce capital costs.

Systems may include a stripper column. The stripper column may include a first section of packing and a first inlet. Systems may in addition include a second section of packing. Systems may also include a bypass inlet configured to deliver a fluid to a top of the second section of packing. Systems may further include a first heat exchanger. The first heat exchanger may include a first inlet and a first outlet. Systems may in addition include a first flow path from the first heat exchanger to the stripper column. The first flow path may include the first outlet of the first heat exchanger and the first inlet of the stripper column. Systems may also include a second flow path from a location upstream of the first inlet of the first heat exchanger to the bypass inlet.

Methods may include flowing a first portion of a first stream to the top of a first section of packing. The first portion of the first stream is at a first temperature. The first stream may include the component. The first stream is a first liquid stream at the first temperature. Methods may in addition include flowing a second portion of the first stream to a first inlet of a stripper column. The second portion of the first stream is at a second temperature. The second temperature is higher than the first temperature. The first inlet is below the top of the first section of packing. Methods may also include flowing a third portion of the first stream to a second inlet of the stripper column. The third portion of the first stream is at a third temperature. The third temperature is higher than the second temperature. The second inlet is below the first inlet. The third portion of the first stream is a first vapor stream at the third temperature. Methods may further include flowing the first vapor stream up through the stripper column and through the first section of packing. Methods may in addition include flowing the first liquid stream down through the first section of packing and through the stripper column. Methods may also include transferring the component from the first liquid stream into the first vapor stream. Methods may further include condensing the first vapor stream to a second liquid stream to obtain a second vapor stream may include the component, thereby separating the component.

Systems may include a stripper column. The stripper column may include a first section of trays and a first inlet. Systems may in addition include a second section of trays. Systems may also include a bypass inlet configured to deliver a fluid to a top of the second section of trays. Systems may further include a first heat exchanger. The first heat exchanger may include a first inlet and a first outlet. Systems may in addition include a first flow path from the first heat exchanger to the stripper column. The first flow path may include the first outlet of the first heat exchanger and the first inlet of the stripper column. Systems may also include a second flow path from a location upstream of the first inlet of the first heat exchanger to the bypass inlet.

Methods may include flowing a first portion of a first stream to the top of a first section of trays. The first portion of the first stream is at a first temperature. The first stream may include the component. The first stream is a first liquid stream at the first temperature. Methods may in addition include flowing a second portion of the first stream to a first inlet of a stripper column. The second portion of the first stream is at a second temperature. The second temperature is higher than the first temperature. The first inlet is below the top of the first section of trays. Methods may also include flowing a third portion of the first stream to a second inlet of the stripper column. The third portion of the first stream is at a third temperature. The third temperature is higher than the second temperature. The second inlet is below the first inlet. The third portion of the first stream is a first vapor stream at the third temperature. Methods may further include flowing the first vapor stream up through the stripper column and through the first section of trays. Methods may in addition include flowing the first liquid stream down through the first section of trays and through the stripper column. Methods may also include transferring the component from the first liquid stream into the first vapor stream. Methods may further include condensing the first vapor stream to a second liquid stream to obtain a second vapor stream may include the component, thereby separating the component.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 shows the base case design of Piperazine with the Advanced Stripper (PZAS).

FIG. 2 shows a system for separation using a direct contact condenser according to embodiments of the present invention.

FIG. 3 is a flowchart for a process of separating a component from a stream according to embodiments of the present invention.

FIG. 4 shows a process flow diagram for base case with direct contact condenser instead of CO₂ exchanger according to embodiments of the present invention.

FIG. 5 shows a graph of the heat duty versus packed height in the direct contact condenser according to embodiments of the present invention.

FIG. 6 shows a graph of the rich loading in the cold rich bypass leaving the direct contact condenser versus the packing height in the direct contact condenser according to embodiments of the present invention.

FIG. 7 shows graphs of temperature and flux profiles in the stripper column according to embodiments of the present invention.

FIG. 8 shows a graph of a reduced gas temperature leaving the direct contact condenser relative to the base case according to embodiments of the present invention.

FIG. 9 shows a graph of condenser duty versus packing height according to embodiments of the present invention.

FIG. 10 shows costs of different equipment versus packing height according to embodiments of the present invention.

FIG. 11 is a graph of sensitivity of annual operating costs and purchased equipment cost according to embodiments of the present invention.

FIG. 12 shows a process flow diagram for base case with double the number of cross exchangers with direct contact condenser instead of CO₂ exchanger according to embodiments of the present invention.

FIG. 13 shows a graph of the heat duty versus packed height in the direct contact condenser according to embodiments of the present invention.

FIG. 14 shows a graph of the rich loading in the cold rich bypass leaving the direct contact condenser versus the packing height in the direct contact condenser according to embodiments of the present invention.

FIG. 15 shows graphs of temperature and flux profiles in the stripper column according to embodiments of the present invention.

FIG. 16 shows a graph of a reduced gas temperature leaving the direct contact condenser relative to the base case according to embodiments of the present invention.

FIG. 17 shows a graph of condenser duty versus packing height according to embodiments of the present invention.

FIG. 18 shows costs of different equipment versus packing height according to embodiments of the present invention.

FIG. 19 is a graph of sensitivity of annual operating costs and annualized purchased equipment cost according to embodiments of the present invention.

FIG. 20 shows total cost of capture versus packing height according to embodiments of the present invention.

FIG. 21 shows the effect of total rich bypass on heat duty and residual condenser duty downstream of the direct contact condenser for scenario 1 according to embodiments of the present invention.

FIG. 22 shows the effect of total rich bypass on heat duty and residual condenser duty downstream of the direct contact condenser for scenario 2 according to embodiments of the present invention.

FIG. 23 shows the effect of using different total rich bypass on heat duty for scenario 1 according to embodiments of the present invention.

FIG. 24 shows the effect of using different total rich bypass on gas temperature leaving direct contact condenser for scenario 1 according to embodiments of the present invention.

### DETAILED DESCRIPTION

An additional section of packing or trays at the top of a stripper replaces a CO₂ exchanger (i.e., a heat exchanger using a CO₂ and water vapor stream to heat a cold rich bypass stream), a major cost center, with the additional section of packing or trays at the top of the stripper acting as a direct contact condenser. Scenarios demonstrated that replacing the CO₂ exchanger with a direct contact condenser can reduce heat duty in the steam heaters and boilers through the additional stripping provided in the additional packing or trays section. Scenarios also demonstrated additional cooling of the gas leaving the stripper compared to the base case. A condenser and a knock out (KO) drum may be eliminated. These benefits may include reduced capital cost of boilers, steam heaters, condensers, KO drums, and air coolers for water wash in the absorber.

The additional section of packing or trays in a stripper may reduce capital costs in scenarios involving a solvent at a high temperature (e.g., greater than or equal to 130° C.) and/or high pressure (e.g., greater than or equal to 2.5 bar). With solvents at lower temperatures and/or lower pressures, a stripper column may have a larger diameter. At these larger diameters, an additional section of packing may result in capital costs that are higher than using a heat exchanger. Additionally, one of ordinary skill in the art would not understand the benefits of using an additional section of packing or trays without proceeding with analysis similar to that described herein. Accordingly, one of ordinary skill in the art would not have been motivated to replace a heat exchanger with the additional section of packing or trays.

In general the terms and phrases used herein have their art-recognized meaning, which can be found by reference to standard texts, journal references, and contexts known to those skilled in the art. The following definitions are provided to clarify their specific use in the context of the disclosure.

“Stripper” or “stripper column” refer to a vessel where the physical separation process of stripping occurs. Stripping involves removing components from a liquid stream by a vapor stream. Stripping may be carried out in a packed column or trayed column. Packed columns increase contact area between liquid and vapor phases. Different types of packing may be commercially available.

“Fluid communication” may refer to the relationship of two locations to each other, where a fluid (e.g., a liquid or a gas) may flow from one location to the other with little or no interference (e.g., do not pass through a reactor or separation unit operation). Additionally, two locations may be in fluid communication if a fluid can occupy a path between the two locations, and a wave propagating through the fluid at one location would travel to the other location.

“Flow path” may refer to a conveyance from one location to another location. For example, a flow path may include a pipe configured to deliver a fluid from one location to another location. The flow path may be direct or indirect. An indirect flow path may pass through a different unit operation (e.g., a reactor) from one location to another location.

### I. Introduction

Several authors have investigated advanced stripper configurations with the potential to reduce the energy requirement of CO₂ stripping compared to the simple stripper process [1]-[12]. Unlike previous efforts, this disclosure includes an advanced stripping process through a combination of cold rich bypass, warm rich bypass, and an advanced solvent (5 molal piperazine [PZ]) that operates at high pressure (e.g., 5 bar) and high temperature in the stripper. This is an improvement on the Piperazine with the Advanced Stripper (PZAS) system. The cold rich bypass is directly sent to a packed direct contact condenser on top of the stripper column, which replaces the CO₂ exchanger. The cold rich bypass condenses the water vapor leaving the stripper while enabling some additional stripping in the high temperature regions, which leads to additional cooling of gas and a lowering of rich loading prior to solvent entry into the stripper column. In this direct contact condenser, the cold rich bypass is preheated using the vapor leaving the stripper and is mixed with another warm rich bypass drawn from in between the cold and hot cross exchangers. The total rich bypass is then sent to the top of the stripper column, which operates at high pressure and temperature with 5 m PZ as solvent.

The PZAS (Piperazine with the Advanced Stripper) process has been developed at the University of Texas at Austin. Experiments with a wetted wall column established that 5 m PZ absorbs CO₂ two to three times faster than monoethanolamine (MEA) [13]. The measured amine vapor pressure of 5 m loaded PZ is significantly less than 7 m MEA [14]. At 163° C., aqueous PZ degrades at the same rate as MEA at 121° C. [15, 16]. Aqueous PZ does not oxidize at absorber conditions but may have a significant rate of oxidative degradation when cycled to 150° C. [17]. The corrosion properties of PZ allow carbon steel to be used at absorber conditions but may use 304 SS at high stripper temperature (150° C.) [18]. The process thermodynamics and absorption rate are represented accurately in Aspen Plus® by rigorous rate-based modeling with the Independence™ thermodynamics model [19]. Several pilot plant campaigns have demonstrated the performance and reliability of the PZAS process. It was demonstrated at coal conditions (12% CO₂ in air) in four campaigns from 2010 to 2018 at the University of Texas at Austin Separations Research Program (SRP). In 2018, 2000 hours of operation with 0.5 MW of coal-fired flue gas at the National Carbon Capture Center (NCCC) validated the process model and confirmed low levels of solvent oxidation. The process was tested with 4% CO₂ in two campaigns at SRP in 2017 and 2018. 1000 hours of operation at SRP in 2022 showed that NO₂ can play a major role in solvent oxidation [20]. More details can be found in the patents by Rochelle et al. [21, 22], the entire contents of which are incorporated herein by reference.

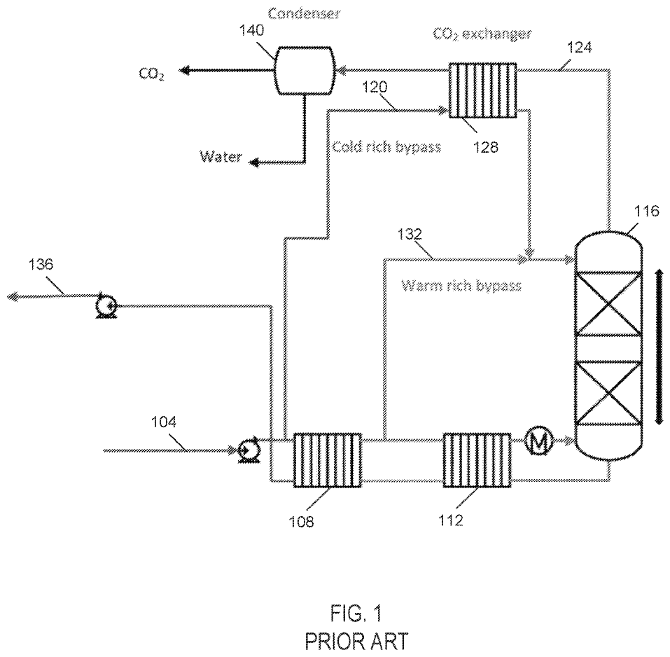

FIG. 1 shows a design of the regeneration section of a CO₂ capture unit with the PZAS system. The design includes two parallel CO₂ absorption/solvent regeneration trains followed by dedicated CO₂ compression and dehydration units for each individual train. In each train, flue gas from the stacks is transferred via the induced draft fans and combined with flue gas from the gas boiler before entering the bottom of the absorber. The flue gas is countercurrently contacted with 5 m piperazine (PZ) (30 wt %) to remove 90% of the CO₂. Wash water in the top bed of the absorber removes PZ vapor from the gas before it exits the stack at the top of the absorber. The absorber intercooler controls the solvent temperature by removing enthalpy from the hot entering flue gas and the heat of CO₂ absorption in the bottom of the column. Rich solvent stream 104 leaving the absorber flows through a series of heat exchangers 108 and 112 before entering pressurized stripper 116. A cold rich bypass 120 exchanges heat with the gas 124 exiting the stripper in CO₂ exchanger 128. Cold rich bypass 120 and warm rich bypass 132 combine before entering the stripper and cool the CO₂ further as it leaves the stripper. Lean solvent 136 returns to the absorber through the solvent heat exchangers. A small fraction of lean solvent is sent to the reclaimers to remove degradation products and return clean solvent. Product CO₂ is cooled in the CO₂ cooler and pressurized in the CO₂ compressors before it is sent to the CO₂ pipeline. Condensed water following condenser 140 from the CO₂ stream is removed in the knock out drums and sent to the wash water storage tank. Steam produced from the gas boilers is used to heat the rich solvent in the steam heaters. More details can be found in the patent by Rochelle et al. [23], the entire contents of which are incorporated herein by reference for all purposes.

The base case stripper design includes a high pressure stripper that operates at 5.5 bar with a bottom temperature of 150° C. The stripper includes two sections of random packing with a total packed height of 7.4 m and a diameter of 3.4 m. The top section contains RSR 2 packing and the bottom section RSR 3 packing. High pressure and high temperature stripping in conjunction with the heat exchanger network reduces the energy requirement of stripping while also reducing the downstream compressor work requirement. The cold cross exchanger was designed with a total NTU (number of heat transfer units) of 5.3, the hot cross exchanger with a total NTU of 1.7, and the CO₂ exchanger with a NTU of 3.8. The use of the cold and warm rich bypasses in the process is instrumental in reducing the energy requirement of the process. A combination of the two bypasses is used in the base case resulting in nearly 70% of the solvent being bypassed to the stripper overhead. The cold bypass recovers latent heat from the water vapor leaving the stripper in the CO₂ exchanger and eliminates a cold-side heat exchanger pinch in the cold cross exchanger. When combined with the warm rich bypass at an advantageous value, the bypassed solvent to the top of the stripper may also eliminate any pinches in the stripper column, allowing for a more reversible stripper operation. Detailed design specifics for the stripper section have been provided by Suresh Babu and Rochelle [24], and Closmann et al. [25].

II. System with Direct Contact Condenser

This document includes an improvement to the base case of the PZAS process. The improvement eliminates the CO₂ exchanger and replaces it with an additional section of packing at the top of the stripper column. The additional section of packing may condense the water vapor leaving the second section of packing in the stripper using the cold rich bypass through a direct-contact method unlike the CO₂ exchanger. This modification results in several benefits.

The modification may eliminate the capital cost associated with the CO₂ exchanger. Being a gas-liquid, shell-and-tube exchanger, the CO₂ exchanger was the most expensive cross exchanger in the base case. Details on the cost breakdown for the base case are provided by Rochelle et al. [26].

The additional section of packing on top of the stripper provides an opportunity to further cool the vapor leaving the stripper using the cold rich bypass, which could partially or fully eliminate the downstream condenser and knock out drums, reducing the CAPEX (capital expenditure) of the process.

The additional section of packing on top of the stripper may allow some further stripping of the solvent due to a high bottom section temperature. This may reduce the energy requirement of the process further compared to the base case energy requirement, thus reducing the OPEX (operating expenditure).

The reduced energy requirement may reduce the overall CAPEX of the plant through a reduction in the size (and cost) of the new steam heaters, standalone gas-fired boilers, air-coolers for the water wash section, condenser, and KO drums.

This modification may reduce the footprint associated with the CO₂ exchanger, condenser, and knock out drums by vertically integrating these operations in an additional section of packing at the top of the stripper. This may be especially useful when the PZAS process is employed in locations with a space constraint.

When used with a stripper at elevated pressure (3-10 bar), the capital cost of the additional section of packing will be minimized or reduced. This may involve solvents that are resistant to thermal degradation, such as aqueous piperazine.

### A. Example Systems

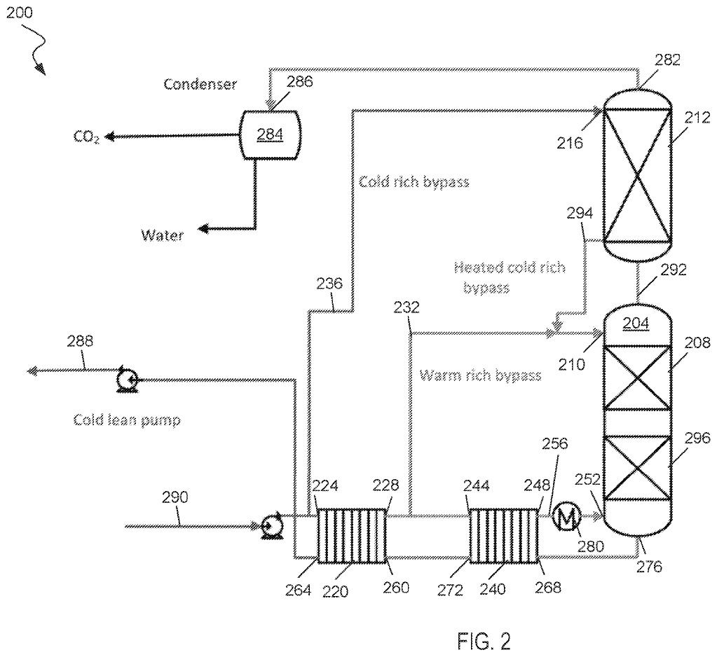

FIG. 2 shows a system 200 for separations. System 200 may include a stripper column 204. Stripper column 204 may include a first section of packing 208 and a first inlet 210. First inlet 210 may be at the top of first section of packing 208. System 200 may in addition include a second section of packing 212. Second section of packing 212 may have a height in a range from 5 feet to 10 feet, 10 feet to 15 feet, 15 feet to 20 feet, or 20 feet to 30 feet. Second section of packing 212 may be referred to as a direct contact condenser.

As illustrated in FIG. 2, stripper column 204 may include a third section of packing 296. First section of packing 208, second section of packing 212, and third section of packing 296 may each separately and independently be random packing or structured packing. In some embodiments, trays may be used instead of packing.

System 200 may also include a bypass inlet 216 configured to deliver a fluid to a top of second section of packing 212. System 200 may further include a first heat exchanger 220. First heat exchanger 220 may include a first inlet 224 and a first outlet 228. System 200 may in addition include a first flow path 232 from the first heat exchanger 220 to stripper column 204. First flow path 232 may be a warm rich bypass. First flow path 232 may include first outlet 228 of first heat exchanger 220 and first inlet 210 of stripper column 204. System 200 may also include a second flow path 236 from a location upstream of first inlet 224 of first heat exchanger 220 to bypass inlet 216.

Stripper column 204 may include second section of packing 212. Stripper column 204 may have a diameter in a range from 2 feet to 5 feet, 5 feet to 10 feet, 10 feet to 15 feet, 15 feet to 20 feet, or 20 feet to 30 feet. The total packing in the stripper column 204 may have a height in a range from 10 feet to 15 feet, 15 feet to 20 feet, 20 feet to 30 feet, 30 feet to 35 feet, 35 feet to 45 feet, 45 feet to 50 feet, or 50 feet to 60 feet. The amount of packing in second section of packing 212 may be in a range from 10% to 20%, 20% to 25%, 25% to 30%, 30% to 35%, 35% to 40%, 40% to 45%, 45% to 50%, or 50% to 55% of the total amount of packing in stripper column 204 (and including second section of packing 212, if second section of packing 212 is not in stripper column 204). These amounts for trays may be similar as amounts for packing. In FIG. 2, when stripper column 204 includes second section of packing 212, streams 292 and 294 may be within stripper column 204. Stripper column 204 may have a height of 80 feet to 90 feet, 90 feet to 100 feet, 100 feet to 110 feet, 110 feet to 120 feet, or greater than 120 feet.

In some embodiments, stripper column 204 may not include second section of packing 212. Second section of packing 212 may be in a separate vessel. Accordingly, the separate vessel may have a different diameter and/or height as stripper column 204. The separate vessel may have a diameter in a range from 5 feet to 10 feet, 10 feet to 15 feet, 15 feet to 20 feet, or 20 feet to 30 feet. The separate vessel may have a height in a range from 5 feet to 10 feet, 10 feet to 15 feet, 15 feet to 20 feet, or 20 feet to 30 feet. In FIG. 2, when stripper column 204 does not include second section of packing 212, streams 292 and 294 may be outside stripper column 204.

Stripper column 204 may include bypass inlet 216. Stripper column 204 may include a second outlet 282. System 200 may include a condenser 284. Condenser 284 may include an inlet 286. Inlet 286 of condenser 284 may be in fluid communication with second outlet 282 of stripper column 204.

System 200 may include a second heat exchanger 240. Second heat exchanger 240 may include a first inlet 244 and a first outlet 248. First outlet 228 of first heat exchanger 220 may be in fluid communication with first inlet 244 of second heat exchanger 240. Stripper column 204 may further include a second inlet 252. System 200 may include a third flow path 256. Third flow path 256 may include first outlet 248 of second heat exchanger 240 and second inlet 252 of stripper column 204

First heat exchanger 220 may include a second inlet 260 and a second outlet 264. Second heat exchanger 240 may include a second inlet 268 and a second outlet 272. Stripper column 204 may include a first outlet 276. First outlet 276 of stripper column 204 may be in fluid communication with second inlet 268 of second heat exchanger 240. Second outlet 272 of second heat exchanger 240 may be in fluid communication with second inlet 260 of first heat exchanger 220.

System 200 may include a heater 280. Heater 280 may be configured to heat fluid between first outlet 248 of second heat exchanger 240 and second inlet 252 of stripper column 204. Heater 280 may be a convective steam heater.

System 200 may include an absorber. The absorber may include an inlet and an outlet. System 200 may include a recycle flow path 288. The outlet of the absorber may be in fluid communication with first inlet 224 of first heat exchanger 220. Recycle flow path 288 may include first outlet 276 of stripper column 204 and the inlet of the absorber. The absorber is not shown in FIG. 2, but the absorber may be connected to recycle flow path 288 and absorber outlet stream 290.

System 200 may exclude a heat exchanger used to capture heat from a stripper overhead gas stream. System 200 may exclude a gas-liquid, shell-and-tube exchanger. For example, system 200 may exclude CO₂ exchanger 128.

System may include the fluid. The fluid may include an aqueous solution of an amine. Examples of suitable solvents include, but are not limited to, aqueous solution of monoethanolamine (MEA), of piperazine (PZ), or of other amines. More specifically, the solvent may be an aqueous blend of piperazine or other reactive amines with a tertiary amine or hindered amine that does not form a carbamate, such as piperazine/methyldiethanolamine, piperazine/2-aminopropanolamine, 2-methylpiperazine and piperazine/2-piperidine-ethanol. The solvent may include reactive primary or secondary amines, such as diglycolamine and diethanolamine. The solvent may use enzymes or other catalysts to enhance CO₂ absorption rate, such as methyldiethanolamine with one or more enzymes. The solvent may be a blend of piperazine with other thermally stable amines, such as piperazine/aminoethylpiperazine and piperazine/2-methylpiperazine. The solvent may be ionic liquid containing amine functionalities.

### B. Example Methods

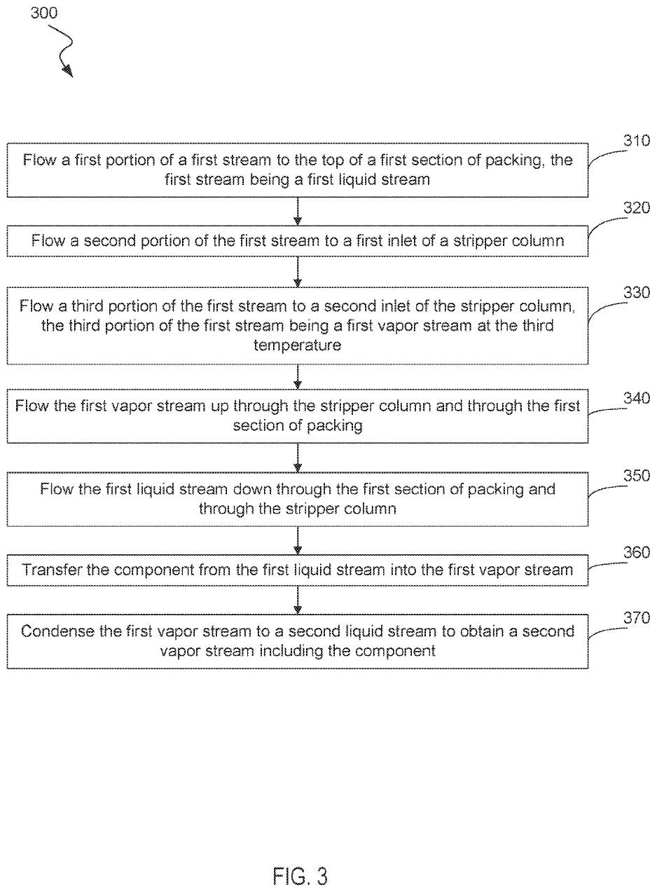

FIG. 3 is a flowchart of an example process 300 of separating a component from a stream. In some implementations, one or more process blocks of FIG. 3 may be performed by system 200. The component may be carbon dioxide or other acid gases, such as hydrogen sulfide or sulfur dioxide.

At block 310, process 300 may include flowing a first portion of a first stream to the top of a first section of packing. The first portion may be from 5% to 10%, 10% to 15%, 15% to 20%, or 20% to 25% of the first stream. The first portion of the first stream may be at a first temperature. The first temperature may be from 30 to 35° C., from 35 to 40° C., 40 to 45° C., 45 to 50° C., or 50 to 60° C. The first stream may include the component. The first stream may be a first liquid stream at the first temperature. The first section of packing may be in the stripper column. The first portion of the first stream may correspond to second flow path 236. The first section of packing in process 300 may correspond to the second section of packing 212. The stripper column may correspond to stripper column 204. As explained with system 200, trays may be used instead of packing. Accordingly, process 300 may be performed with trays replacing any mention of packing.

Process 300 may further include flowing the first stream from an absorber. The component may be carbon dioxide. The solvent may include water and an amine, including any amine described herein. The first stream may have a first loading of greater than or equal to 0.4 moles of carbon dioxide per moles of nitrogen. For example, the first loading may be 0.4 to 0.5, 0.5 to 0.6, or 0.6 to 0.7. The first stream may correspond to absorber outlet stream 290.

At block 320, process 300 may include flowing a second portion of the first stream to a first inlet of a stripper column. The second portion may be 20% to 30%, 30% to 40%, 40% to 45%, 45% to 50%, 50% to 55%, or 55% to 60% of the first stream. The second portion of the first stream may be at a second temperature. The second temperature may be higher than the first temperature. The second temperature may be from 100 to 110° C., 110 to 120° C., 120 to 130° C., or 130 to 140° C. The first inlet may be below the top of the first section of packing. The first inlet may be first inlet 210. The second portion of the first stream may be first flow path 232.

At block 330, process 300 may include flowing a third portion of the first stream to a second inlet of the stripper column. The third portion may be 20% to 25%, 25% to 30%, 30% to 35%, 35% to 40%, 40% to 50%, 50% to 60%, or 60% to 70% of the first stream. The first portion, the second portion, and the third portion may be the entirety of the first stream. The third portion of the first stream may be at a third temperature. The third temperature may be higher than the second temperature. The third temperature may be at least 130° C., including 130 to 140° C., 140 to 150° C., 150 to 160° C., 160 to 170° C., 170 to 180° C., or greater than 180° C. Process 300 may include heating the third portion of the first stream to the third temperature using a steam heater. The second inlet may be below the first inlet. The third portion of the first stream may be a first vapor stream at the third temperature. The third portion of the first stream may be at a pressure of at least 2.5 bar, including 2.5 to 3.0 bar, 3.0 to 3.5 bar, or over 3.5 bar. The second inlet may be second inlet 252. The third portion may correspond to third flow path 256.

At block 340, process 300 may include flowing the vapor up through the stripper column and through the first section of packing. For example, flowing the first vapor stream up may include flowing the first vapor stream in stream 292.

At block 350, process 300 may include flowing the first liquid stream down through the first section of packing and through the stripper column. For example, flowing the first liquid stream down may include flowing the liquid stream in stream 294.

At block 360, process 300 may include transferring the component from the first liquid stream into the first vapor stream. Transferring the component may be the result of mass transfer that occurs in stripper columns.

At block 370, process 300 may include condensing the first vapor stream to a second liquid stream to obtain a second vapor stream may include the component, thereby separating the component. Condensing the vapor stream may be in a condenser. The stripper column may not include the condenser. In some embodiments, no condenser separate from the stripper column may be present for this condensing step. The condenser may be condenser 284. The second liquid stream may be the water stream in FIG. 2. The second vapor stream may be the CO₂ stream in FIG. 2.

The first stream may include the component at a first fraction. The first fraction may be a mass fraction of 0.20 to 0.30, 0.25 to 0.30, 0.30 to 0.35, 0.35 to 0.40, or 0.40 to 0.50. Process 300 may further include flowing a bottoms stream through a first outlet of the stripper column. The bottoms stream may include the component at a second fraction. The second fraction may be less than the first fraction. The second fraction may be a mass fraction of 0.01 to 0.05, 0.05 to 0.10, 0.10 to 0.15, 0.15 to 0.20, or 0.20 to 0.25. The second fraction may be reduced compared to the first fraction by 25% to 30%, 30% to 40%, 40%, to 50%, 50% to 60%, 60% to 75%, or greater than 75%. Process 300 may further include cooling the bottoms stream with the second portion of the first stream. Cooling the bottoms stream further may include cooling the bottoms stream with the third portion of the first stream. For example, the first outlet may be first outlet 276. Heating and cooling streams may be by using heat exchangers, such as first heat exchanger 220 and second heat exchanger 240.

Process 300 may further include flowing the bottoms stream to the absorber. The bottoms stream may have a second loading of less than or equal 0.2. For example, the second loading may be 0.15 to 0.20, 0.10 to 0.15, or 0.05 to 0.10. The loading in the bottoms stream may be reduced compared to the first stream by 25% to 30%, 30% to 40%, 40%, to 50%, 50% to 60%, 60% to 75%, or greater than 75%.

Process 300 may include additional implementations, such as any single implementation or any combination of implementations described and/or in connection with one or more other processes described elsewhere herein.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

### III. Examples

Embodiments of the invention may be further understood by the following non-limiting examples. Two scenarios, with different heat transfer units and pressure drop in the cold and hot cross exchangers, were evaluated with this replacement in place for their benefits, process tradeoffs, and economic viability. Both scenarios demonstrated that replacing the CO₂ exchanger with a direct contact condenser can reduce heat duty in the steam heaters and boilers through the additional stripping provided in the third packing section, albeit with some reabsorption in the colder regions. Both scenarios also demonstrated additional cooling of the gas leaving the stripper compared to the base case, and in scenario 2, the higher cold rich bypass brings the gas leaving the stripper closer to equilibrium with the liquid entering the stripper, almost eliminating the need for a condenser and knock out (KO) drum. These benefits mean reduce capital cost of boilers, steam heaters, condensers, and KO drums.

### A. Modeling Methods

The modeling of PZAS for the base case and for the proposed improvement were done in Aspen Plus®. A rate-based modeling approach was employed which uses the Song mass transfer model [27] for mass transfer coefficients and wetted area of packing in the packed columns and the Independence™ thermodynamic model [28] to describe the vapor-liquid-equilibrium, physical properties, and rate-behavior of 5 m piperazine. The bottom two sections of the stripper column were modeled with equilibrium reactions at high temperature with an empirical correction of 0.16 applied to the wetted area of packing [29]. The new, third section of packing on top of the stripper is modeled differently, using kinetic reactions at lower temperature and with no correction applied to the wetted area [30]. This packing section behaves partially as an absorber in the low temperature region and as a stripper in the high temperature region, making the use of a single wetted area correction factor inaccurate. The design model was used to evaluate the performance of the base case for the process, and rating models were used to more accurately model every other scenario shown in this document. Suresh Babu et al. [31] give a detailed description of the design and rating models. A combination of design and rating models were used to validate the hypotheses in this work. For a scenario with double the number of cross exchangers, a hot lean pump upstream of the hot cross exchanger and downstream of the stripper sump replaced the cold lean pump to compensate for the increased pressure drop and to avoid cavitation. The pump power was estimated in this case in a design mode, with a specified pressure increase based on the elevation head in the lean line going into the absorber and with a pump efficiency of 65%.

### B. Cost Scaling and Economic Evaluation Method

For the cost scaling, the Purchased Equipment Cost (PEC) of the following units was considered using the base case costs as a reference point: cold cross exchangers, hot cross exchangers, CO₂ exchanger, steam heaters, rich and lean solvent pumps, intercooler pumps in absorber, intercooler air coolers for absorber, packaged boilers, CO₂ compressor, CO₂ condenser and knock out drums, stripper vessel (packing and other internals), and air coolers for water wash. The total Direct Field Cost (DFC) of all equipment in the base case study was $384.1 MM, and this was converted to a PEC using a factor of 1.98 which yielded 760.5 MM $. In the evaluation of the new designs shown in this document, the costs of the above equipment are expected to change due to a change in process variables including steam heater duty, boiler heat duty, heat exchanger pressure drop, and condenser duty. Costs of absorber intercooler air cooler and pumps were held constant as they are not expected to change with these new configurations. For the other costs, a simple power law scaling using the 0.6 factor was used as shown below.

$$\frac{New DFC}{Base case DFC} = {[ \frac{New scaling variable}{Scaling variable for base case} ]}^{0.6} \qquad ( 1 )$$

In the table below, the base case DFC and the scaling variable used for each piece of equipment is shown.

TABLE 1
Base case Direct Field Costs (DFC) for equipment
considered along with cost scaling variable

| | Base case DFC for both | |
|---|---|---|
| | parallel process trains put | Scaling variable/constant |
| Equipment | together (MM$) | chosen |
| Cold cross exchanger | 0.99 | 1 or 2, constant multiplier |
| Hot cross exchanger | 0.55 | 1 or 2, constant multiplier |
| CO₂ exchanger | 3.49 | 0, equipment eliminated |
| Steam heaters | 3.54 | Steam heater heat rate |
| Rich solvent pump | 3.22 | Power |
| Lean solvent pump | 1.22 | Power |
| Intercooler pumps | 2.36 | Fixed |
| Intercooler air coolers | 20.72 | Fixed |
| Packaged boilers | 9.76 | Boiler heat rate |
| CO₂ compressor | 12 | CO₂ flow rate |
| CO₂ condenser and KO drum | 1.72 | Condenser duty |
| Stripper packing | 0.3 (60% of total quoted | Area of packing |
| | internal cost) | |
| Stripper vessel | 3.26 | External surface area, power |
| | | law factor = 1 (instead of 0.6) |
| Stripper distributors and | 0.2 (40% of total quoted | 1.5, constant multiplier |
| support plates | internal cost) | |
| Air cooler for water wash | 14.87 | Steam heater heat rate |

To convert the PEC to an annualized PEC, the total direct cost was first multiplied by the scaling factor α and then by the annualizing factor β. The scaling factor includes the direct and indirect installation cost, contingency, contractor's fee, and auxiliary facilities. The annualizing factor considers the return on investment, taxes, depreciation, and maintenance. α was chosen to be 1.98 and β was chosen to be 0.2 in this work. The annualized PEC may then be normalized by the total CO₂ flow per year according to the formula below.

$$Annualized PEC ( \frac{\$}{tonne {CO}_{2}} ) = Direct Field Cost * α * \frac{β}{{CO}_{2} flow ( \frac{toone}{yr} )} \qquad ( 2 )$$

where:
α=capital cost scaling factor=1.98;
β=annualizing factor=0.2.

In addition to the PEC, for the two scenarios developed in this work, the annualized operating cost was estimated. For this, a gas price of $3/MMBtu and an electric power price of $25/MWh was assumed. The heat rate of the natural gas fired boilers was the primary component of the cost for heating. Rich pump and lean pump power requirements varied in the two scenarios, which contributed to different costs for electric power. In addition to solvent pumping, there were other areas of the process that required electric power such as air coolers, and intercooler pumps. The electric power requirement of these components was fixed at the base case value as they were not expected to change with the scenarios presented in this document. Compressor power was estimated based on a surrogate model, as explained by Suresh Babu et al. [26]. For all the costing methods used, a capacity factor of 52% was used. By combining the annualized PEC and annualized operating expenses, a total cost for CO₂ capture was estimated.

C. Scenario 1: Base Case with Direct Contact Condenser Instead of CO₂ Exchanger

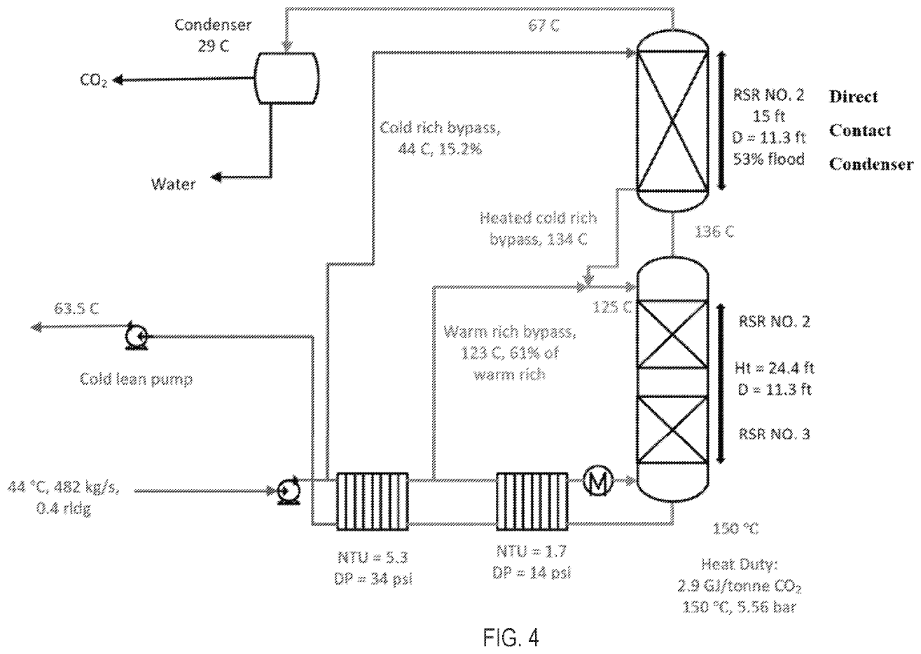

The first scenario considers the replacement of the CO₂ exchanger with a packed, direct contact condenser at the top of the stripper column, with the same number and size of cold and hot cross exchangers as the base case design. A sensitivity analysis was conducted with varying packing height in the direct contact condenser to observe its effects on steam heater duty, condenser duty, gas temperature, rich loading, and equipment costs compared to the base case design. The tradeoffs and benefits have been highlighted. In this scenario, the cold and hot cross exchangers have the same pressure drop as the base case design, and therefore the rich and lean pumps have approximately the same electric power requirement as the base case design. The cold and warm rich bypass flow rates have been specified to be the same as the advantageous values for the base case design to individually highlight the effect of replacing the CO₂ exchanger with a direct contact condenser. FIG. 4 shows the process flow diagram for this case.

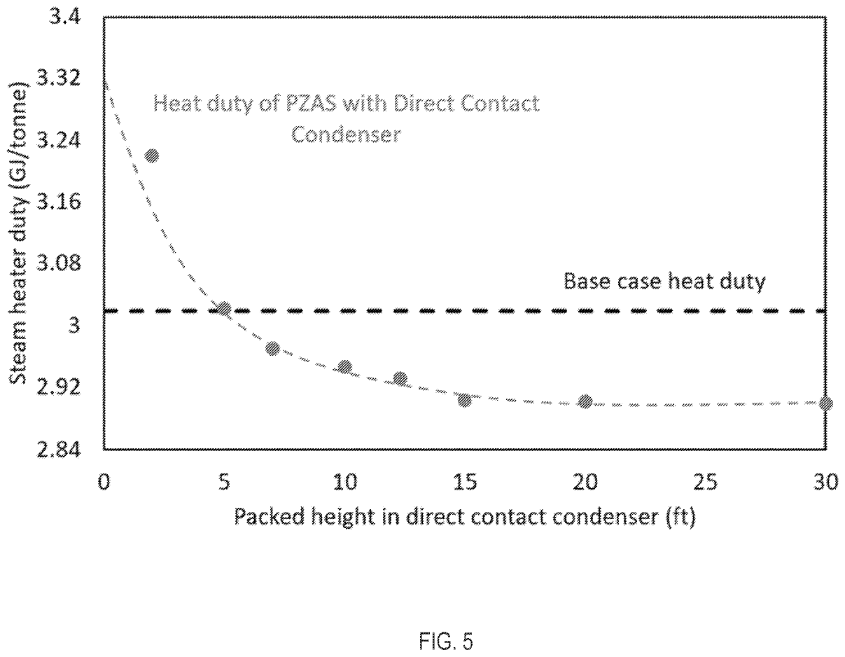

The packing height in the direct contact condenser was increased from 2 ft to 30 ft. The packing type used was RSR 2. Below 5 ft of packing, the direct contact condenser underperformed compared to the CO₂ exchanger. The heat duty, as shown in FIG. 5, was higher than the base case heat duty of 3 GJ/tonne. 5 ft of packing in the direct contact condenser was adequate to match the heat duty of the base case design. As the packing height was increased further, the heat duty decreased monotonically, ultimately approaching 2.9 GJ/tonne.

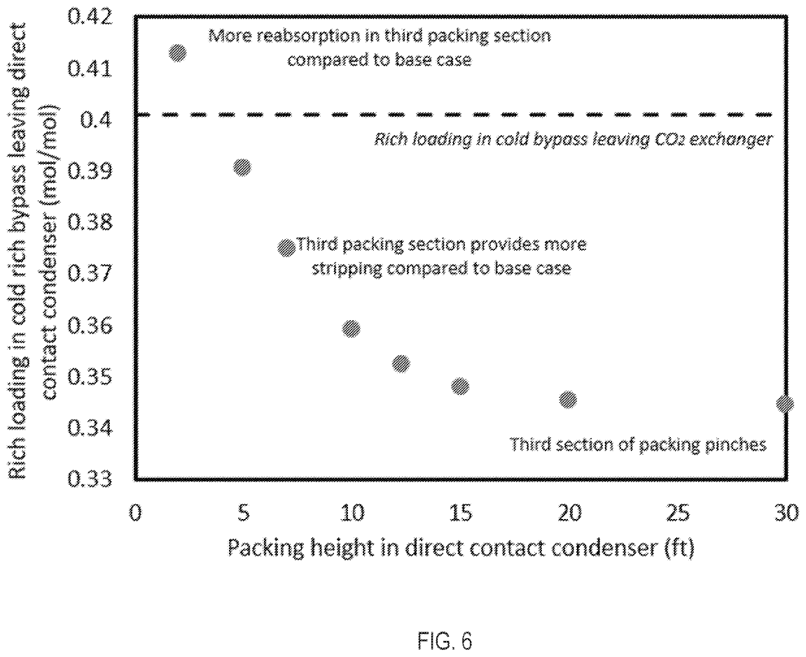

Below 5 ft of packing in the direct contact condenser, the net effect of reabsorption in this section of packing outweighs the stripping, resulting in a higher rich loading in the cold rich bypass solvent exiting the section, compared to that with the CO₂ exchanger. In addition to this, the temperature of the vapor leaving the stripper is higher than the base case, due to the lack of adequate packing to enable condensation of water in the stripper. Ultimately, this increased the condenser duty at 85° F. compared to the base case design. The effect of packing height on rich loading in the heated cold rich bypass stream is shown in FIG. 6.

FIG. 6 also shows that as the packing in the direct contact condenser is increased, the packed section works as a stripper more than it does as an absorber, which is reflected in the reduced rich loading in the heated cold rich bypass solvent leaving this packed section compared to that leaving the CO₂ exchanger in the base case design. This demonstrates that despite the reabsorption occurring in cold end of the direct contact condenser, the direct contact condenser could produce additional stripping on top of the main stripper column, which yields a lower heat duty, gas temperature, and ultimately condenser duty compared to the base case design.

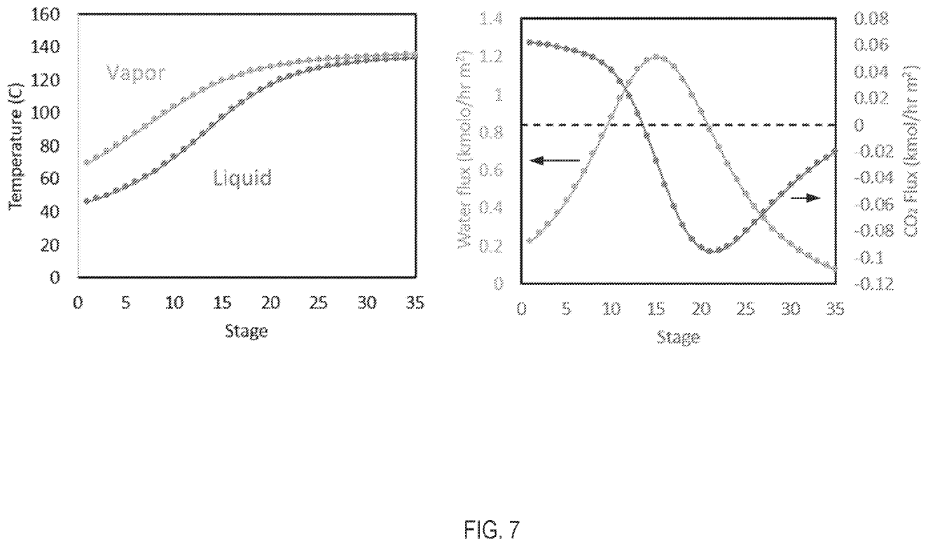

The stripper liquid and vapor temperature profiles are shown in FIG. 7 for a direct contact condenser with a total packing height of 12.3 ft, which represents three symmetric packed sections on top of each other in the stripper column. The diameter of the direct contact condenser was made equal to that of the stripper column. Stage 1 is top of column; stage 35 is bottom of column. The total packing height in direct contact condenser is 12.3 ft. A negative CO₂ flux indicates stripping. The lean loading (lldg) is 0.2 mol/mol. The rich loading (rldg) is 0.4 mol/mol. The cold rich bypass split fraction is 15.2%. The warm rich bypass split fraction is 52% (e.g., second portion in process 300). FIG. 7 shows that the direct contact condenser aids in additional stripping.

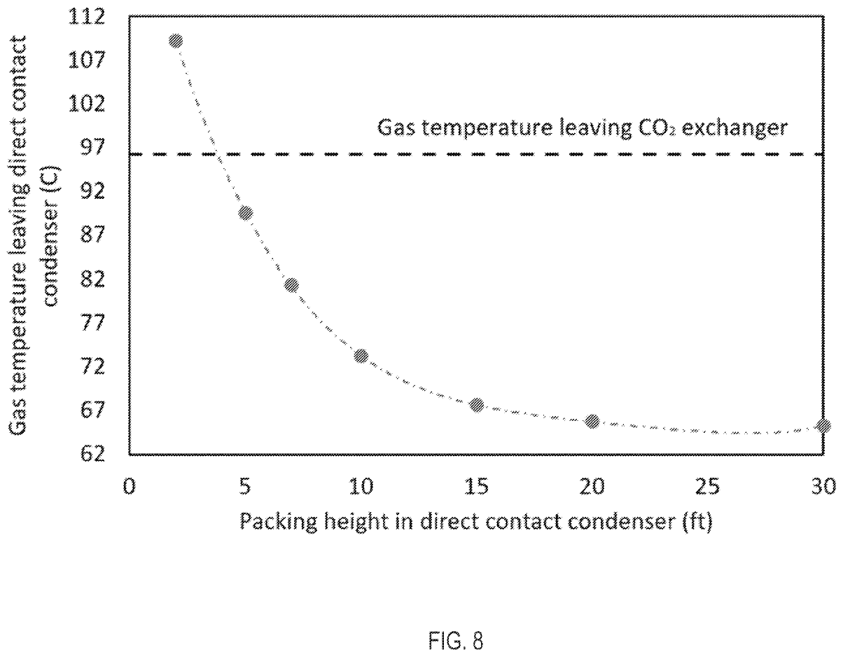

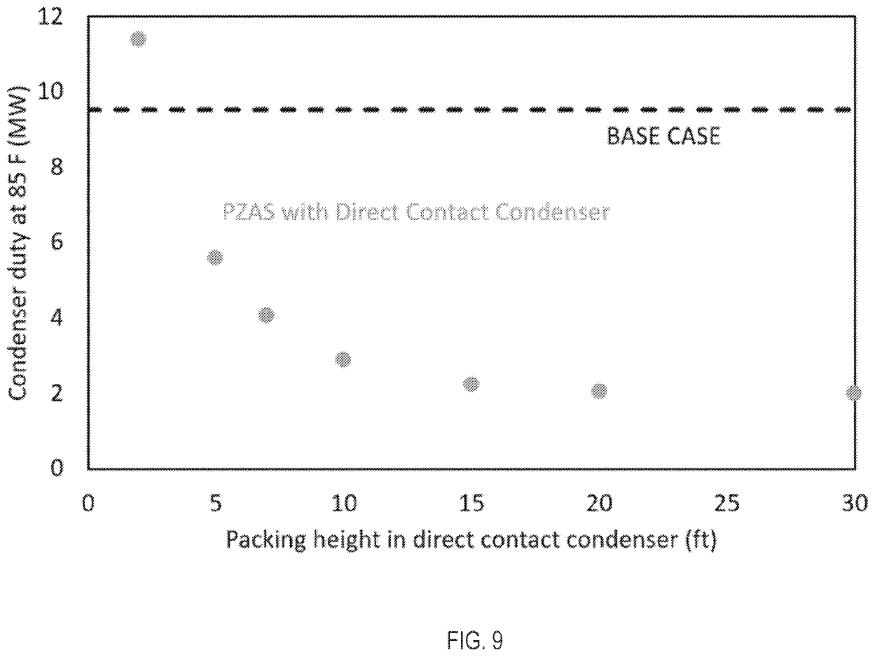

FIG. 8 shows that above a packing height of about 5 ft, the gas temperature leaving the direct contact condenser can be decreased below the gas temperature leaving the CO₂ exchanger at the same flow of cold rich bypass through these units. The direct contact condenser allows for additional stripping of CO₂ and cooling of the gas through condensation. This results in a lower condenser duty as shown in FIG. 9, which indicates that using the direct contact condenser over the CO₂ exchanger could result in partial or complete elimination of the condenser and knock out drums.

FIG. 9 shows that the additional cooling of the gas in the direct contact condenser reduces the condenser duty downstream with increasing packing height. This may mean a lower condenser and KO drum cost when the base case costs are scaled using condenser duty. At a packing height of about 30 ft, the condenser duty is only 2 MW relative to the base case duty of about 10 MW, indicating that the condenser may be completely eliminated from the design, but this point may not be economically optimal considering that the cost of stripper packing and internals may be the greatest at this high packing height.

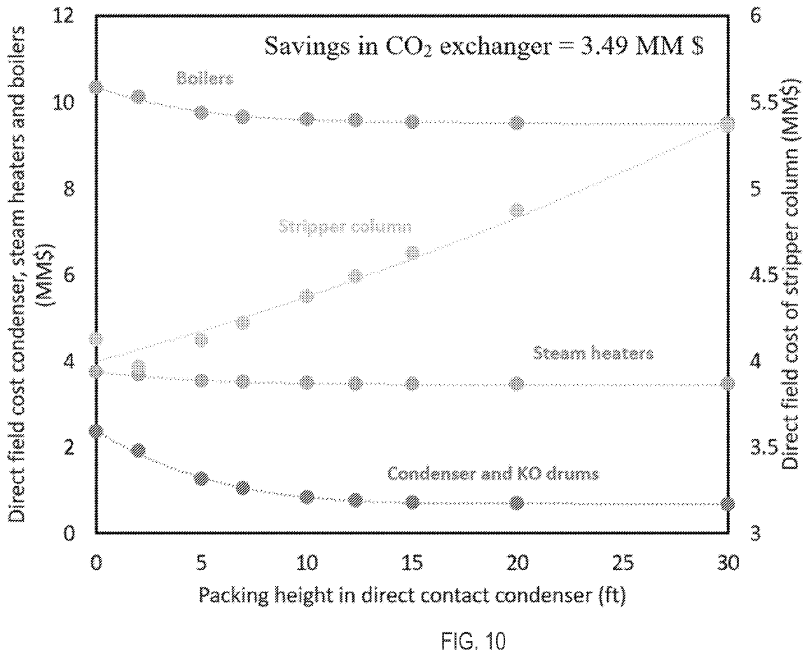

FIG. 10 shows the estimated Direct Field Cost (DFC) of the boilers, steam heaters, condenser and KO drums, and the stripper column using the scaling methodology described previously. FIG. 10 shows that the use of direct contact condenser may reduce the cost of boilers, steam heaters, condenser, and KO drums. The three main cost centers that showed significant reduction in Direct Field Cost are shown. The reduction in cost of boilers and steam heaters can be attributed to the reduced heat duty with increasing packing height in the direct contact condenser relative to the base case design. The reduction in the cost of the condenser and KO drums can be attributed to the reduced condenser duty with increasing packing height in the direct contact condenser. At very high packing height the cost of the condenser and KO drums approaches 1 MM$. The increase in the cost of the stripper column can be attributed to the increased shell surface area and increased packing area due to the addition of the direct contact condenser.

Cost details at 0 ft packing height were scaled from the base case design using heat duty, boiler heat rate, and condenser duty extrapolated from the curves shown in previous figures. At 0 ft packing height in the stripper, the additional cost of the stripper is associated with the stripper shell and internals, but not additional packing compared to the base case. Cost of other equipment such as pumps and CO₂ compressor did not change much due to very similar pressure drop in exchangers and CO₂ flow rate of this design compared to the base case design.

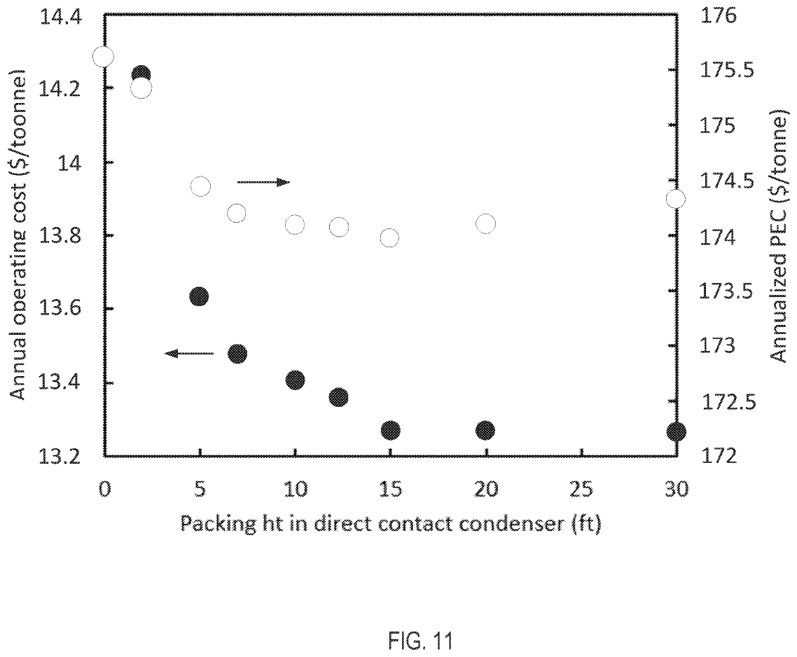

FIG. 11 shows how annualized PEC and operating cost vary as the packing height is increased in the direct contact condenser. As the packing height increases, annualized operating cost levels out beyond 15 ft of packing due to approximately constant heat duty at greater packing height. Heat duty is the only variable that changes with packing height, with the electric power being approximately constant. Annualized PEC decreases until 15 ft as most equipment costs have been scaled with heat duty, but beyond 15 ft of packing the costs of added packing and internals in the column overtake this reduction. This may result in a minimum total cost right around 15 ft and this height may likely not vary with gas or power price but could vary with other variables such as packing type in stripper, CO₂ content in flue gas, or stripper pressure.

D. Scenario 2: Base Case with Double the Number of Cross Exchangers with the Direct Contact Condenser

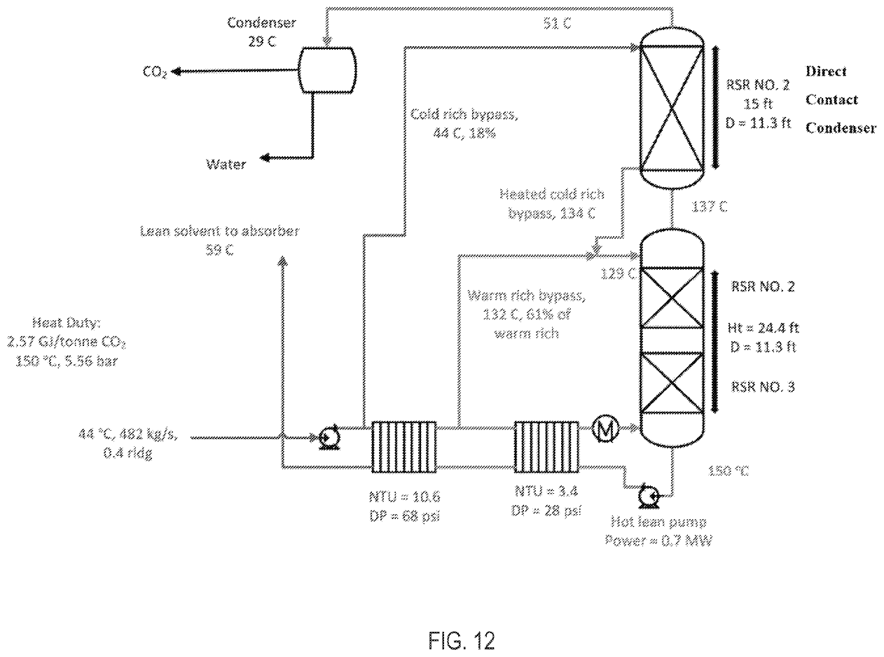

This scenario evaluates the economic viability of and conducts a sensitivity analysis on the base case with double the number of cross exchangers or double the heat transfer units in the cross exchangers and a direct contact condenser instead of the CO₂ exchanger. The modeling and economic methods used are the same as before. The rich pump cost and performance is not expected to change under this scenario as it is a fixed speed pump that puts out a given pressure for a given flow of liquid. The lean pump may need to be placed downstream of the stripper sump and before the hot exchanger. The pressure drop on the cold and hot sides of the cross exchangers double due to a doubling of path length for the same flow. The base case design pressure drop was modified, and the rating model was then used to readjust the bypasses and evaluate the configuration. The lean pump, if placed downstream of the heat exchangers, may cavitate under certain operating conditions due to the high pressure drop in this case, and therefore should be placed upstream of all the cross exchangers. FIG. 12 shows the process flow diagram for this case.

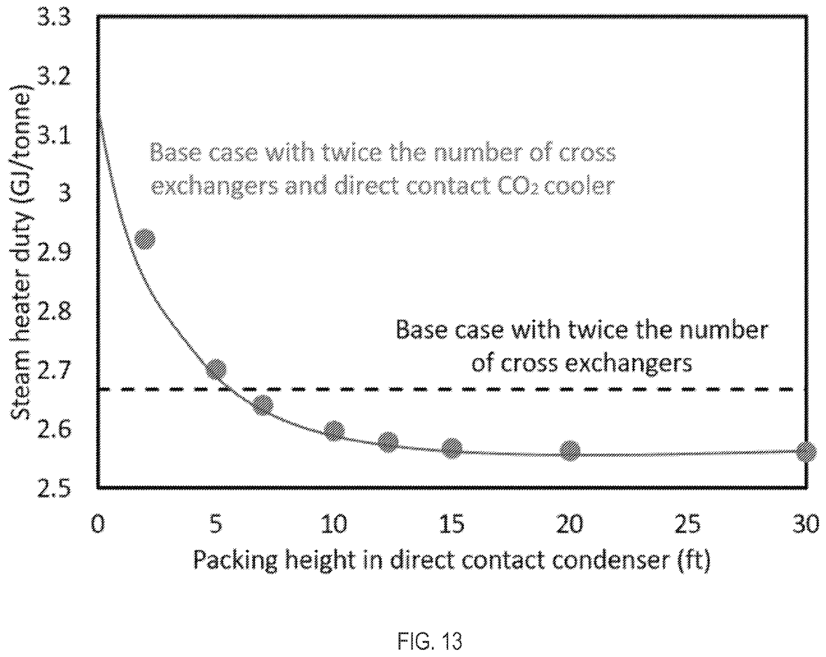

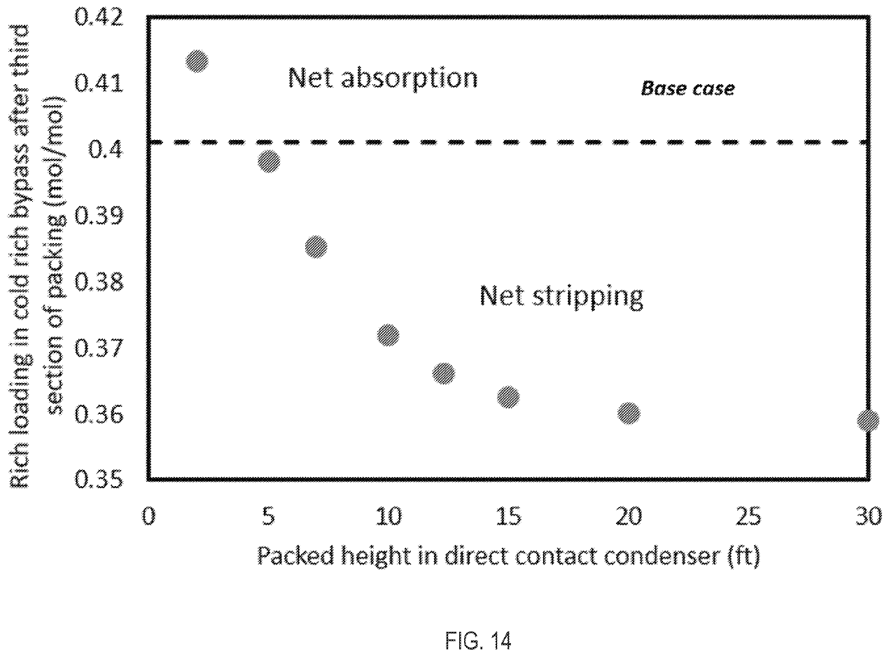

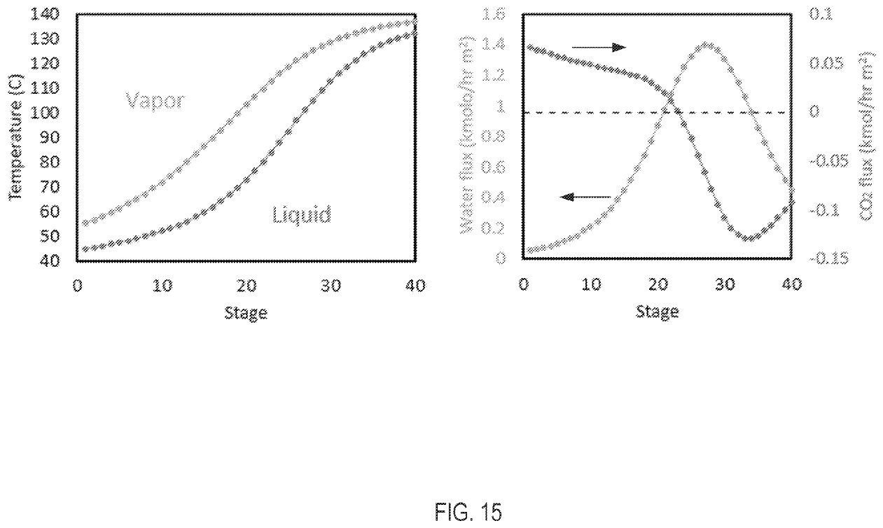

FIG. 13 shows the sensitivity of steam heater duty to packing height added to the direct contact condenser, with twice as many cross exchangers as the PZAS base case. Compared to scenario 1, the heat duty is lower, directly correlating with the increased heat exchange area, but compared to the heat duty with double the number of cross exchangers and the CO₂ exchanger, the heat duty change is similar to scenario 1. The heat duty of the original base case design is still about 3 GJ/tonne. The cold rich bypass flow is slightly higher than scenario 1, giving rise to more condensation of water and consequently more cooling of the gas leaving the direct contact condenser. FIG. 14 shows that, as in scenario 1, at about 5 ft of packing in the direct contact condenser, the net stripping of CO₂ in the column is higher than the rate of reabsorption giving rise to lower rich loading in the heated cold rich bypass leaving the section of the column. The base case rich loading in the cold rich bypass leaving the CO₂ exchanger is still about 0.4 mol/mol. Stripper temperature profiles for a packing height of 12.3 ft in the direct contact condenser are shown in FIG. 15.

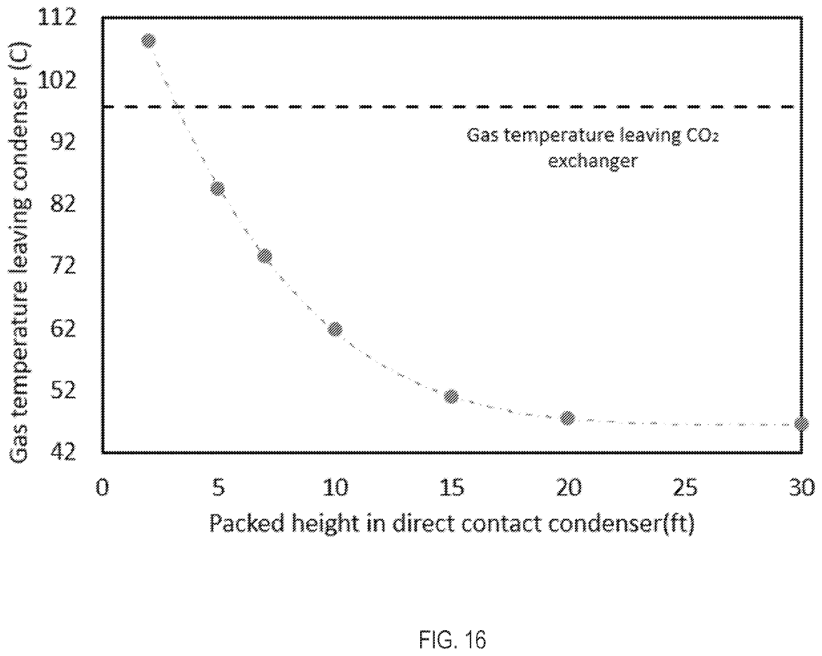

FIG. 16 shows that with scenario 2, the gas temperature leaving the direct contact condenser can be lower than scenario 1 for the same packing height in the section primarily due to the higher amount of cold rich bypass. This independently highlights the effect of cold rich flow through the section. At a packing height of 20 ft or above, the gas temperature leaving the direct contact condenser is about 42° C. bringing it almost to equilibrium with the cold rich bypass entering the column. In this case, the condenser duty downstream may be close to zero due to almost complete condensation of water in the stripper column. This may further reduce the cost of the condenser and KO drum for this scenario compared to the base case and scenario 1 and may almost eliminate the need for this equipment.

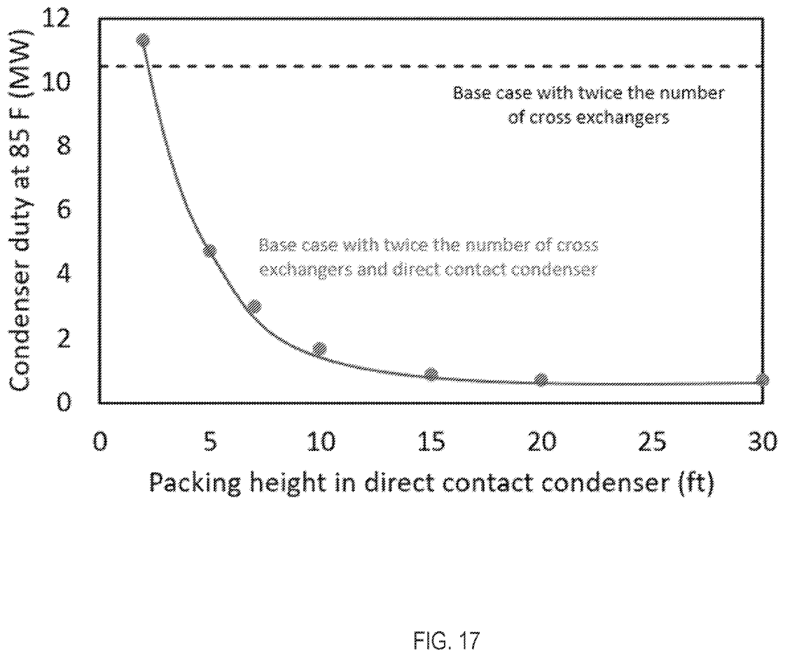

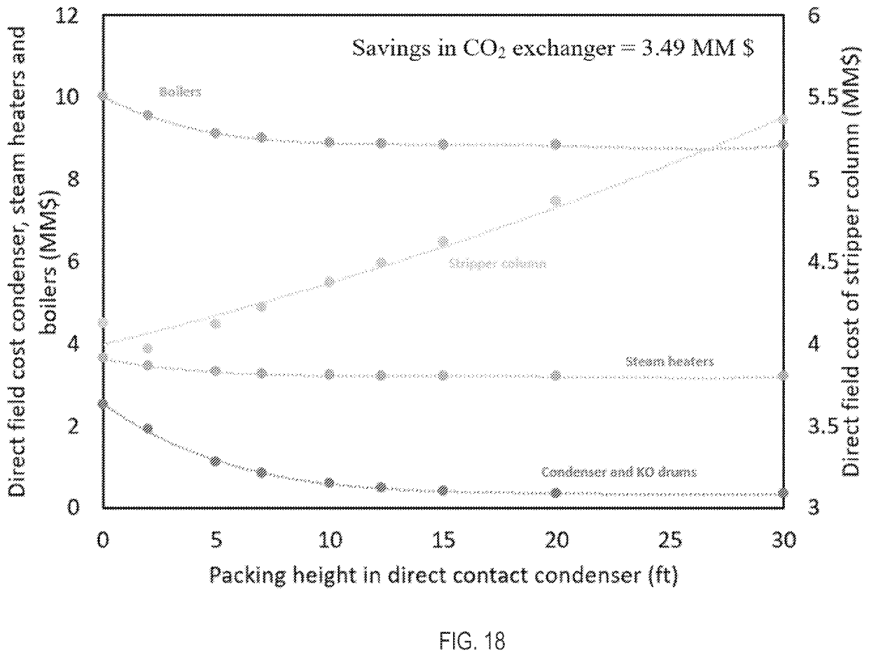

FIG. 17 shows that as the packing height in the direct contact condenser is increased, the condenser duty drops just as, but slightly lower than, in scenario 1, due to the higher cold rich bypass. At very high packing height, the condenser duty can be reduced to almost zero compared to the base case condenser duty of about 10 MW. This almost eliminates the need for a condenser and KO drums as seen in FIG. 18. Boilers and steam heaters show a reduction in cost as in scenario 1 but are slightly lower due to the lower heat duty of the boiler and steam heaters in scenario 2. This happens at the expense of added capital for the shell, internals, and packing in the stripper column as more packing is added to the direct contact condenser.

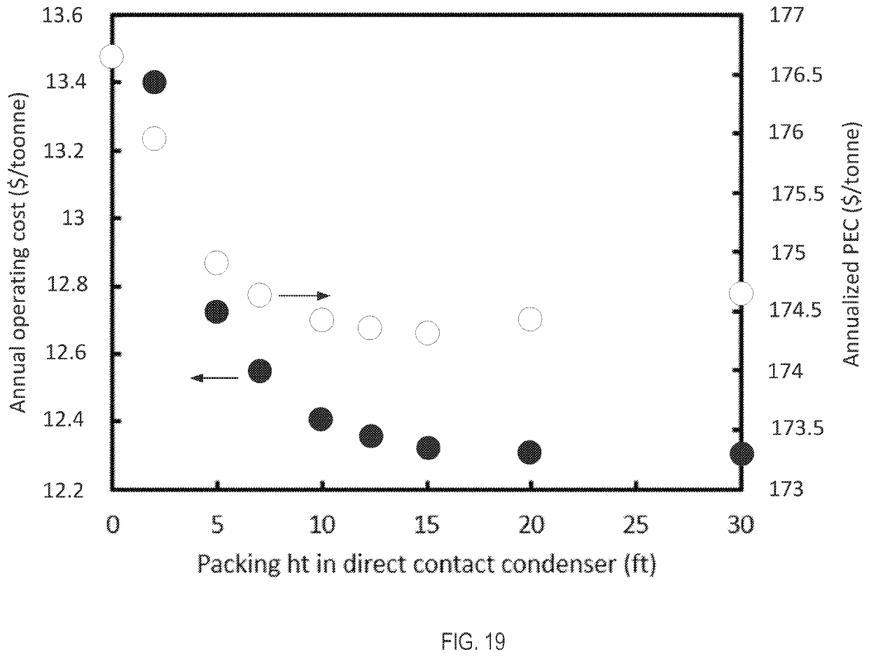

FIG. 19 shows how annualized PEC and operating costs vary as the packing height is increased in the direct contact condenser. Heat duty is approximately constant at greater packing height so annualized operating cost levels out beyond 15 ft of packing. Heat duty is the only variable that changes with packing height, the electric power being approximately constant. Annualized PEC decreases until 15 ft as most equipment costs have been scaled with heat duty, but beyond 15 ft the cost of added packing and internals in the column negate this reduction. This may result in an minimum total cost at 15 ft and this height may likely not vary with gas or power price but could vary with other variables such as packing type in stripper, CO₂ content in flue gas, or stripper pressure.

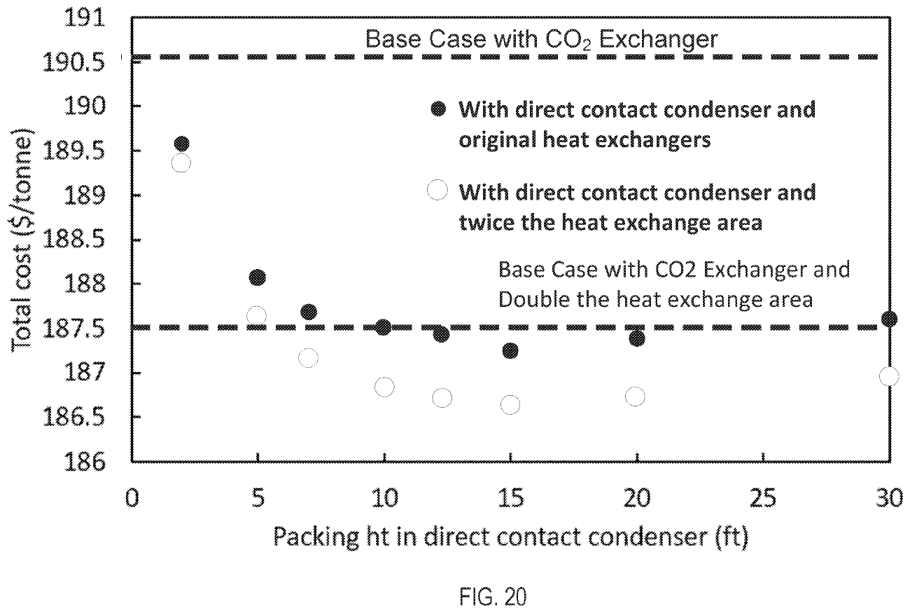

FIG. 20 compares the annualized total cost of scenario 1 and scenario 2 with the base case design. Firstly, the figure shows that both scenarios are cheaper than the base case design. This indicates that replacing the CO₂ exchanger in the base case by a direct contact condenser is always cheaper irrespective of heat exchanger size and packing height added to the direct contact condenser. The annualized total cost of capture at a packing height of about 15 ft in the direct contact condenser can be up to 4$/tonne lower than the base case design. Scenario 2 with double the number of cross exchangers is less expensive than scenario 1 irrespective of packing height, due to a lower energy cost from the lower heat duty, despite the added cost of heat exchangers and lean pump. The higher pressure drop in the cross exchangers increases the elevation head that the lean pump works against, increasing the electric work of the lean pump from 0.18 MW in the base case design to about 0.7 MW in scenario 2. This increased the cost of the lean pump, as estimated by the cost-scaling method from about 1.2 MM$ to 2.7 MM$.

### E. Effect of Bypass Flow on the Performance of Direct Contact Condenser

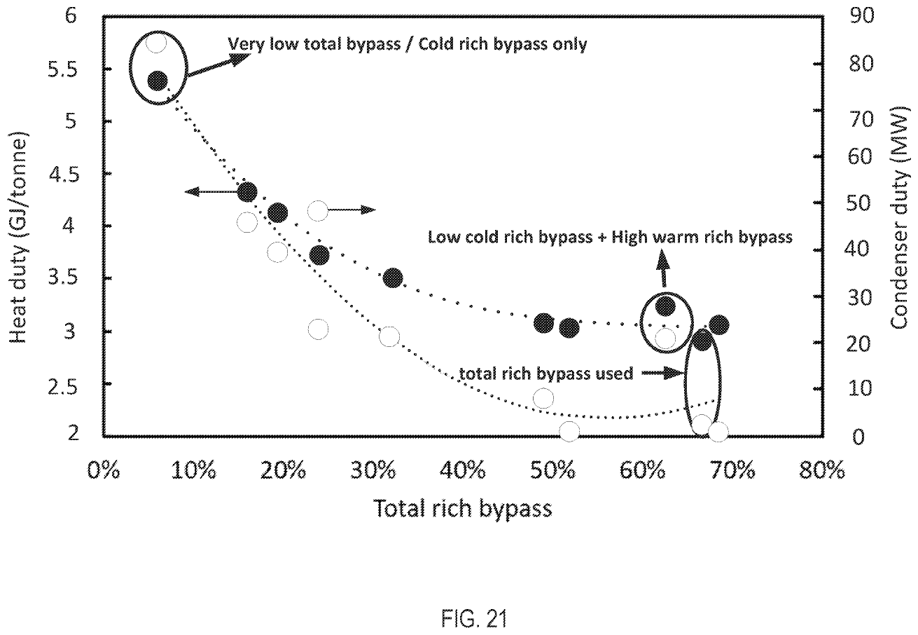

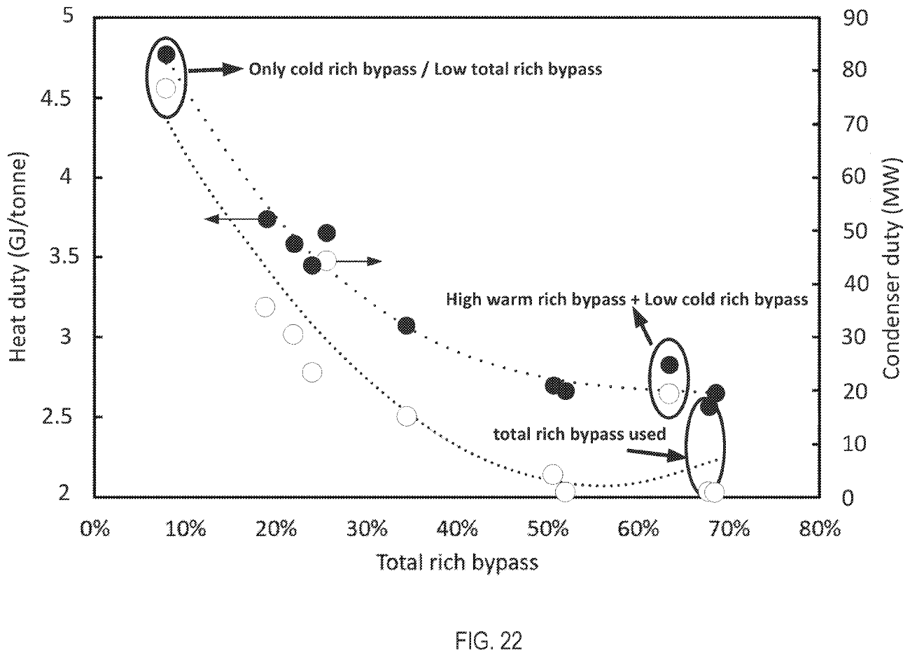

The scenarios developed in the previous sections were evaluated at the advantageous bypass flow rates for their respective cases with the CO₂ exchanger. This section describes a sensitivity analysis on the bypass flow rate keeping the stripper packing height fixed at the value of 15 ft to see its effect on heat duty and the direct contact condenser. In FIG. 21 and FIG. 22, heat duty decreases when more total rich bypass is used. At one extreme, when very low cold rich bypass or very low total rich bypass is used, the heat duty is higher than that of the case with total rich bypass at between 65% to 70%. At this condition, due to the use of very little cold rich bypass, there is little change in vapor temperature in the direct contact condenser because of little water condensation. This also results in a large temperature pinch from the middle to the bottom of that column. In another case where a combination of low cold rich bypass and high warm rich bypass is used, the heat duty is much lower but still not at its optimum value, however, the residual condenser duty is still about 20 MW. At certain value of bypasses, both heat duty and condenser duty are minimized as shown in FIGS. 21 and 22. This also demonstrates that the performance of PZAS with the Direct Contact Condenser will likely be suboptimal with the use of either the cold rich or warm rich bypass only, rather than using both bypasses at their values that minimize or reduce heat duty.

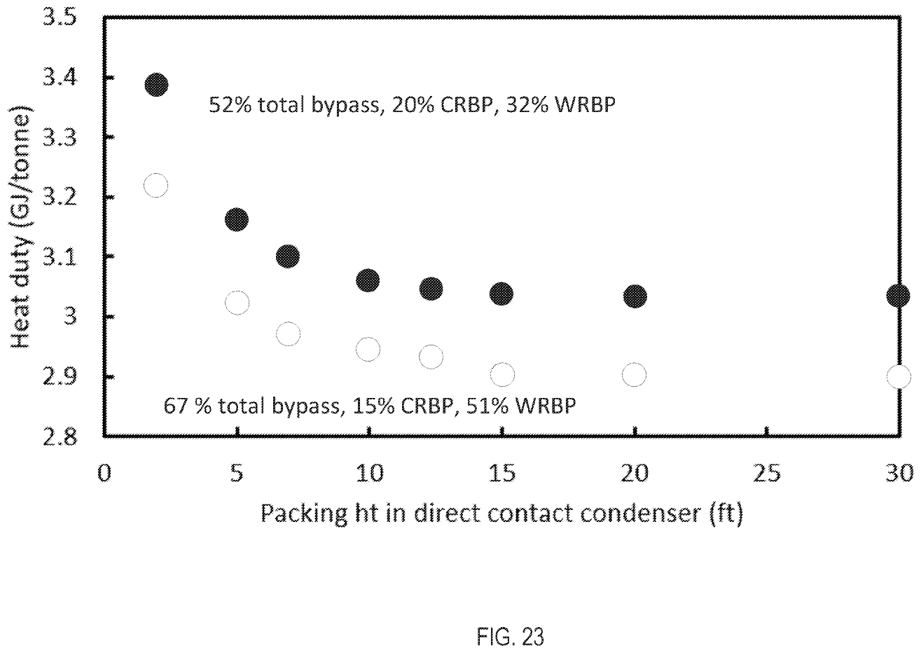

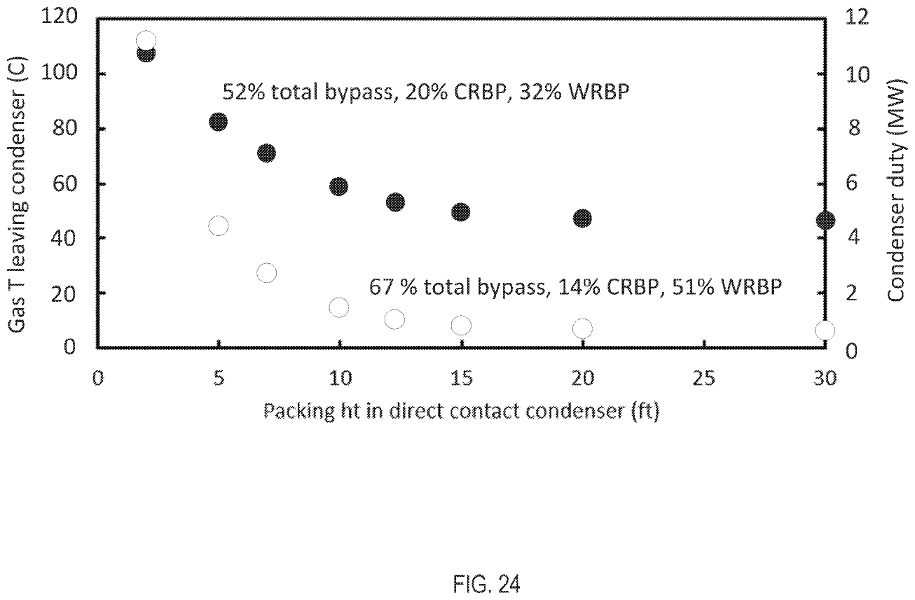

From FIG. 23 and FIG. 24, it appears that the heat duty is approximately constant at high total rich bypass flowrates. This section investigates if a total rich bypass fraction of 50% (relative to the total rich solvent leaving the absorber) has similar effects on heat duty as the total rich bypass fraction of 67%. From FIG. 23, using 50% total rich bypass fraction increases the heat duty by about 4.4% on average as a function of packing height in the direct contact condenser. Importantly, from FIG. 24, using 50% total rich bypass increases not only the gas temperature leaving the packed condenser but also the downstream residual condenser duty. This shows that using suboptimal total rich bypass would most likely result in more expensive steam heaters, standalone gas boilers, CO₂ condenser and KO drums, air cooler for water wash, and the cost of natural gas. At much lower total rich bypass values, the rich solvent pump may also be under designed to accommodate the downstream pressure requirements, especially in scenario 2 where the pressure drop is doubled in the solvent cross exchangers. This could also increase the cost of the rich solvent pump. Overall, using suboptimal bypasses would most likely increase the total annualized cost of capture and decrease the savings obtained from using the direct contact condenser instead of the CO₂ exchanger, although the desired packing height in the direct contact condenser would likely be unaffected.

### F. Summary of Scenarios

The CO₂ exchanger in the PZAS base case design was replaced by a section of packing above the stripper column that used the cold rich bypass to condense the water vapor in the gas leaving the stripper through direct contact. Two designs were evaluated for their benefits and economic viability and compared to the base case design. The scenarios varied in the number of heat transfer units of the cold and hot cross exchangers, and their pressure drop.

Direct Field Costs of boilers, steam heaters, condenser and KO drums, and stripper column were affected primarily by replacing the CO₂ exchanger with a direct contact condenser through a reduction in boiler and steam heater duty, additional cooling of flue gas, and added packing cost in the stripper. Direct Field Costs of this and other equipment were all scaled from the base case design values using appropriate scaling variables.

Both scenarios reduce the heat duty of stripping through additional stripping in the added section of packing despite some reabsorption at the colder areas of packing.

Both scenarios provide additional condensation of water in the third section of packing, which results in a lower gas temperature leaving the column when compared to the base case design. In scenario 2, with additional cold rich bypass through the packing, the need for the condenser and KO drums is almost eliminated, and the gas leaving the stripper is close to equilibrium with the liquid entering the stripper.

A sensitivity analysis of annualized PEC for all equipment in the base case as a function of added packing height in the direct contact condenser showed that at a packing height of about 15 ft, the reduction in annualized total cost of capture for the two scenarios could be up to 4$/tonne CO₂ compared to the base case design.

Scenario 2, with double the heat transfer units in the cross exchangers, shows an increased cost in lean pump due the need for a hot lean pump between the sump of the stripper and the hot exchanger that works against greater elevation head compared to the cold lean pump in the base case design. This increases the lean pump work from 0.18 MW in the base case to 0.7 MW.

### REFERENCES

[1] Bottoms, R. R., 1930. Separating acid gases, Girdler Corp. U.S. Pat. No. 1,783,901.
[2] Liu, J., Wong, D. S. H. and Chen, D. S., 2020. Energy-saving performance of advanced stripper configurations for CO₂ capture by ammonia-based solvents. Journal of the Taiwan Institute of Chemical Engineers, 113, pp. 273-284.
[3] Karimi, M., Hillestad, M. and Svendsen, H. F., 2011. Capital costs and energy considerations of different alternative stripper configurations for post combustion CO₂ capture. Chemical engineering research and design, 89(8), pp. 1229-1236.
[4] Oh, H. T., Ju, Y., Chung, K. and Lee, C. H., 2020. Techno-economic analysis of advanced stripper configurations for post-combustion CO₂ capture amine processes. Energy, 206, p.118164.
[5] Jiang, K., Li, K., Yu, H., Chen, Z., Wardhaugh, L. and Feron, P., 2017. Advancement of ammonia based post-combustion CO₂ capture using the advanced flash stripper process. Applied Energy, 202, pp. 496-506.
[6] Jung, J., Jeong, Y. S., Lim, Y., Lee, C. S. and Han, C., 2013. Advanced CO₂ capture process using MEA scrubbing: Configuration of a split flow and phase separation heat exchanger. Energy Procedia, 37, pp. 1778-1784.
[7] Thompson, J. G., Bhatnagar, S., Combs, M., Abad, K., Onneweer, F., Pelgen, J., Link, D., Figueroa, J., Nikolic, H. and Liu, K., 2017. Pilot testing of a heat integrated 0.7 MWe CO₂ capture system with two-stage air-stripping: Amine degradation and metal accumulation. International Journal of Greenhouse Gas Control, 64, pp. 23-33.
[8] Zhao, B., Liu, F., Cui, Z., Liu, C., Yue, H., Tang, S., Liu, Y., Lu, H. and Liang, B., 2017. Enhancing the energetic efficiency of MDEA/PZ-based CO₂ capture technology for a 650 MW power plant: Process improvement. Applied energy, 185, pp. 362-375.
[9] Dubois, L. and Thomas, D., 2018. Comparison of various configurations of the absorption-regeneration process using different solvents for the post-combustion CO₂ capture applied to cement plant flue gases. International Journal of Greenhouse Gas Control, 69, pp. 20-35.
[10] Li, K., Yu, H., Feron, P., Wardhaugh, L. and Tade, M., 2016. Techno-economic assessment of stripping modifications in an ammonia-based post-combustion capture process. International Journal of Greenhouse Gas Control, 53, pp. 319-327.
[11] Jung, J., Jeong, Y. S., Lee, U., Lim, Y. and Han, C., 2015. New configuration of the CO₂ capture process using aqueous monoethanolamine for coal-fired power plants. Industrial & Engineering Chemistry Research, 54(15), pp. 3865-3878.
[12] Rochelle, G. T., University of Texas System, 2011. Regeneration of an aqueous solution from an acid gas absorption process by multistage flashing and stripping. U.S. Pat. No. 7,901,487.
[13] Dugas R E, CO₂ Absorption, Desorption, and Diffusion in Aqueous PZ and MEA. PhD Dissertation, The University of Texas at Austin, 2009.
[14] Nguyen T. Amine Volatility in CO₂ Capture. PhD Dissertation, The University of Texas at Austin, 2013.
[15] Freeman S A. Thermal Degradation and Oxidation of Aqueous PZ for CO₂ Capture. PhD Dissertation, The University of Texas at Austin, 2011.
[16] Rochelle, G., Du, Y. and Namjoshi, O., University of Texas System, 2017. Thermally stable amines for CO₂ capture. U. S. patent application Ser. No. 15/367,404.
[17] Wu Y. Mitigation of Piperazine Oxidation in Carbon Dioxide Capture by Amine Scrubbing. PhD Dissertation, The University of Texas at Austin, 2022.
[18] Liu C-T. Corrosion of Stainless and Carbon Steel in Aqueous Piperazine for CO₂ Capture. PhD Dissertation, The University of Texas at Austin, 2022.
[19] Frailie P T. Modeling of Carbon Dioxide Absorption/Stripping by Aqueous MDEA/PZ. PhD Dissertation, the University of Texas at Austin, 2014.
[20] Closmann F. Pilot Testing of Mitigation Methods for Piperazine Oxidation. Presented at GHGT-16, Lyon, France Oct. 24-27, 2022.
[21] Rochelle, G. and Hilliard, M., University of Texas System, 2011. Acidic gas capture by diamines. U.S. Pat. No. 7,938,887.
[22] Rochelle, G., Freeman, S., Chen, X., Nguyen, T., Voice, A. and Rafique, H., University of Texas System, 2014. Acidic gas removal by aqueous amine solvents. U.S. Pat. No. 8,816,078.
[23] Rochelle, G., Madan, T. and Lin, Y. J., University of Texas System, 2018. Apparatus for and method of removing acidic gas from a gaseous stream and regenerating an absorbent solution. U.S. Pat. No. 9,956,505.
[24] Babu, A. S. and Rochelle, G. T., 2022. Process design of the piperazine advanced stripper for a 460 MW NGCC. International Journal of Greenhouse Gas Control, 115, p.103631.
[25] Closmann, F., Rochelle, G., Gao, T., Suresh Babu, A., Abreu, M. and Drewry, B., 2021 March. FEED for Piperazine with the Advanced Stripper™ on NGCC at Denver City, Texas. In Proceedings of the 15th Greenhouse Gas Control Technologies Conference (pp. 15-18).
[26] Rochelle, G., Closmann, F., Abreu, M., Suresh Babu, A., Drewry, B., Gao, T., Sexton, A., Dombrowski, K. and Piggott, B., Karen and Bryan, Scott R. and Bernau, Max and Sexton, Andrew and Dombrowski, Katherine and jones, Rosalind and marsh, Michael and Piggott, Brad and Myers, Duane. Cost details from Front-End Engineering Design of piperazine with the advanced stripper. (Aug. 29, 2022).
[27] Song, D., Effect of liquid viscosity on liquid film mass transfer for packings. PhD Dissertation, The University of Texas at Austin, 2017.
[27] Frailie, P. T. Modeling of carbon dioxide absorption/stripping by aqueous methyldiethanolamine/piperazine. PhD Dissertation. The University of Texas at Austin. 2014.
[29] Suresh Babu, A. and Rochelle, G. T., 2021 March. Heat loss and energy use in pilot plant testing of Piperazine with the Advanced Stripper. In Proceedings of the 15th Greenhouse Gas Control Technologies Conference (pp. 15-18).
[30] Gao, T., Absorber modeling and design in amine scrubbing for carbon capture. PhD Dissertation, The University of Texas at Austin, 2021.
[31] Suresh Babu, A., Abreu, M., Drewry, B., Chen, Y. L. and Rochelle, G., 2022. Maximum Operating Profit of PZAS at Off-Design Conditions by a Rigorous Rating Model for a 460 MW NGCC.

### STATEMENTS REGARDING INCORPORATION BY REFERENCE AND VARIATIONS

All references throughout this application, for example patent documents, including issued or granted patents or equivalents and patent application publications, and non-patent literature documents or other source material are hereby incorporated by reference herein in their entireties, as though individually incorporated by reference.

All patents and publications mentioned in the specification are indicative of the levels of skill of those skilled in the art to which embodiments of the invention pertain. References cited herein are incorporated by reference herein in their entirety to indicate the state of the art, in some cases as of their filing date, and it is intended that this information can be employed herein, if needed, to exclude (for example, to disclaim) specific embodiments that are in the prior art.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/or” means that one, all, or any combination of items in a list separated by “and/or” are included in the list; for example “1, 2 and/or 3” is equivalent to “1, 2, 3, 1 and 2, 1 and 3, 2 and 3, or 1, 2, and 3”.

Every formulation or combination of components described or exemplified can be used to practice embodiments of the invention, unless otherwise stated. Specific names of materials are intended to be exemplary, as it is known that one of ordinary skill in the art can name the same material differently. It will be appreciated that methods, device elements, starting materials, and synthetic methods other than those specifically exemplified can be employed in the practice of embodiments of the invention without resort to undue experimentation. All art-known functional equivalents, of any such methods, device elements, starting materials, and synthetic methods are intended to be included in embodiments of this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. Embodiments of the invention illustratively described herein suitably may be practiced in the absence of any element, elements, limitation, or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of embodiments of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A system comprising:
a stripper column, the stripper column comprising a first section of packing and a first inlet;
a second section of packing;
a bypass inlet configured to deliver a fluid to a top of the second section of packing;
a first heat exchanger, the first heat exchanger comprising a first inlet and a first outlet;
a first flow path from the first heat exchanger to the stripper column, the first flow path comprising the first outlet of the first heat exchanger and the first inlet of the stripper column; and
a second flow path from a location upstream of the first inlet of the first heat exchanger to the bypass inlet.

2. The system of claim 1, wherein:
the stripper column comprises the second section of packing, and
the stripper column comprises the bypass inlet.

3. The system of claim 1, further comprising:
a second heat exchanger, wherein the second heat exchanger comprises a first inlet and a first outlet, and
a third flow path,
wherein:
the first outlet of the first heat exchanger is in fluid communication with the first inlet of the second heat exchanger,
the stripper column further comprises a second inlet, and
the third flow path comprises the first outlet of the second heat exchanger and the second inlet of the stripper column.

4. The system of claim 3, wherein:
the first heat exchanger comprises a second inlet and a second outlet,
the second heat exchanger comprises a second inlet and a second outlet,
the stripper column comprises a first outlet,
the first outlet of the stripper column is in fluid communication with the second inlet of the second heat exchanger, and
the second outlet of the second heat exchanger is in fluid communication with the second inlet of the first heat exchanger.

5. The system of claim 4, further comprising a heater, wherein the heater is configured to heat fluid between the first outlet of the second heat exchanger and the second inlet of the stripper column.

6. The system of claim 4, wherein:
the stripper column comprises the second section of packing,
the stripper column comprises the bypass inlet,
the stripper column comprises a second outlet,
the system further comprising a condenser, wherein:
the condenser comprises an inlet, and
the inlet of the condenser is in fluid communication with the second outlet of the stripper column.

7. The system of claim 1, further comprising:
an absorber, the absorber comprising an inlet and an outlet,
a recycle flow path,
wherein:
the outlet of the absorber is in fluid communication with the first inlet of the first heat exchanger,
the stripper column comprises a first outlet, and
the recycle flow path comprises the first outlet of the stripper column and the inlet of the absorber.

8. The system of claim 1, wherein the second section of packing has a height in a range from 10 feet to 20 feet.

9. The system of claim 1, wherein the stripper column has a diameter in a range from 2 feet to 30 feet.

10. The system of claim 1, wherein the stripper column has a total packing height in a range from 10 feet to 60 feet.

11. The system of claim 1, further comprising the fluid, wherein the fluid comprises an aqueous solution of an amine.

12. A method of separating a component from a stream, the method comprising:
flowing a first portion of a first stream to the top of a first section of packing, the first portion of the first stream being at a first temperature, the first stream comprising the component, the first stream being a first liquid stream at the first temperature;
flowing a second portion of the first stream to a first inlet of a stripper column, the second portion of the first stream being at a second temperature, the second temperature being higher than the first temperature, the first inlet being below the top of the first section of packing;
flowing a third portion of the first stream to a second inlet of the stripper column, the third portion of the first stream being at a third temperature, the third temperature being higher than the second temperature, the second inlet being below the first inlet, the third portion of the first stream being a first vapor stream at the third temperature;
flowing the first vapor stream up through the stripper column and through the first section of packing;
flowing the first liquid stream down through the first section of packing and through the stripper column;
transferring the component from the first liquid stream into the first vapor stream; and
condensing the first vapor stream to a second liquid stream to obtain a second vapor stream comprising the component, thereby separating the component.

13. The method of claim 12, wherein the first section of packing is in the stripper column.

14. The method of claim 12, wherein condensing the first vapor stream is in a condenser, and the stripper column does not comprise the condenser.

15. The method of claim 12, wherein the first stream further comprises the component at a first fraction,
the method further comprising:
flowing a bottoms stream through a first outlet of the stripper column, wherein the bottoms stream comprises the component at a second fraction, the second fraction being less than the first fraction, and
cooling the bottoms stream with the second portion of the first stream.

16. The method of claim 15, wherein cooling the bottoms stream further comprises cooling the bottoms stream with the third portion of the first stream.

17. The method of claim 15, further comprising:
flowing the first stream from an absorber, and
flowing the bottoms stream to the absorber.

18. The method of claim 15, wherein:
the component is carbon dioxide,
the first stream comprises a solvent,
the solvent is an amine,
the first stream has a first loading of greater than or equal to 0.4 moles of carbon dioxide per moles of nitrogen,
the bottoms stream has a second loading of less than or equal 0.2.

19.-21. (canceled)

20. A system comprising:
a stripper column, the stripper column comprising a first section of trays and a first inlet;
a second section of trays;
a bypass inlet configured to deliver a fluid to a top of the second section of trays;
a first heat exchanger, the first heat exchanger comprising a first inlet and a first outlet;
a first flow path from the first heat exchanger to the stripper column, the first flow path comprising the first outlet of the first heat exchanger and the first inlet of the stripper column; and
a second flow path from a location upstream of the first inlet of the first heat exchanger to the bypass inlet.

21.-30. (canceled)

22. A method of separating a component from a stream, the method comprising:
flowing a first portion of a first stream to the top of a first section of trays, the first portion of the first stream being at a first temperature, the first stream comprising the component, the first stream being a first liquid stream at the first temperature;
flowing a second portion of the first stream to a first inlet of a stripper column, the second portion of the first stream being at a second temperature, the second temperature being higher than the first temperature, the first inlet being below the top of the first section of trays;
flowing a third portion of the first stream to a second inlet of the stripper column, the third portion of the first stream being at a third temperature, the third temperature being higher than the second temperature, the second inlet being below the first inlet, the third portion of the first stream being a first vapor stream at the third temperature;
flowing the first vapor stream up through the stripper column and through the first section of trays;
flowing the first liquid stream down through the first section of trays and through the stripper column;
transferring the component from the first liquid stream into the first vapor stream; and
condensing the first vapor stream to a second liquid stream to obtain a second vapor stream comprising the component, thereby separating the component.

23.-40. (canceled)
